(19) United States
(12) Patent Application Publication
(10) Pub. No.: US 2010/0041403 A1
(43) Pub. Date: Feb. 18, 2010

(54) Method and Apparatus for Management of UTRAN Radio Network Temporary Identifiers (U-RNTIs) over the Iuh Interface

(76) Inventors: Amit Khetawat, San Jose, CA (US); Michael D. Gallagher, San Jose, CA (US); Patrick Tao, San Jose, CA (US); Rajeev Gupta, Sunnyvale, CA (US)

Correspondence Address: ADELI & TOLLEN, LLP, 11940 San Vicente Blvd., Suite 100, LOS ANGELES, CA, 90049, US

(21) Appl. No.: 12/542,683

(22) Filed: Aug. 17, 2009

Related U.S. Application Data
(60) Provisional application No. 61/089,459, filed on Aug. 15, 2008.
(60) Provisional application No. 61/089,886, filed on Aug. 18, 2008.
(60) Provisional application No. 61/089,889, filed on Aug. 18, 2008.
(60) Provisional application No. 61/159,797, filed on Mar. 12, 2009.
(60) Provisional application No. 61/159,800, filed on Mar. 12, 2009.

(51) Int. Cl. H04W 4/00; H04B 7/00

(52) U.S. Cl. 455/435.1; 455/41.2

(57) ABSTRACT

A method of managing user equipment (UE) identifiers in a communication system that includes a first wireless communications system that has a core network and a second wireless communications system that includes several short range access points using licensed wireless frequencies and a network controller for communicatively coupling a user equipment to the core network. The method receives a radio resource control (RRC) connection request message from the UE. The method allocates a first identifier to the UE. The method sends an RRC connection setup message that includes the first identifier from the access point to the UE. The method sends a connection management services request message and the first identifier. The network controller determines the first identifier is in use. The method sends a mobility info message that includes a second identifier which is different than the first identifier from the access point to the UE.

### CLAIM OF BENEFIT TO RELATED APPLICATIONS

This application claims the benefit of U.S. Provisional Application 61/089,459, entitled “Femtocell System Design”, filed Aug. 15, 2008; U.S. Provisional Application 61/089,886, entitled “Method of Distributing Temporary ID/Permanent ID Relationships in Enterprise Femtocell System”, filed Aug. 18, 2008; U.S. Provisional Application 61/089,889, entitled “Management of UTRAN Radio Network Temporary Identifiers (U-RNTIs) in an Enterprise Femtocell System”, filed Aug. 18, 2008; U.S. Provisional Application 61/159,797, entitled “Management of UTRAN Radio Network Temporary Identifiers (U-RNTIs) Over the Iuh Interface”, filed Mar. 12, 2009; and U.S. Provisional Application 61/159,800, entitled “Inter HNB Cell Update Handling”, filed Mar. 12, 2009. The contents of each of the above mentioned provisional applications are hereby incorporated by reference.

### FIELD OF THE INVENTION

The invention relates to telecommunication. More particularly, this invention relates to a technique for seamlessly integrating voice and data telecommunication services across a licensed wireless system and a short-ranged licensed wireless system.

### BACKGROUND OF THE INVENTION

Licensed wireless systems provide mobile wireless communications to individuals using wireless transceivers. Licensed wireless systems refer to public cellular telephone systems and/or Personal Communication Services (PCS) telephone systems. Wireless transceivers include cellular telephones, PCS telephones, wireless-enabled personal digital assistants, wireless modems, and the like.

Licensed wireless systems utilize wireless signal frequencies that are licensed from governments. Large fees are paid for access to these frequencies. Expensive base station (BS) equipment is used to support communications on licensed frequencies. Base stations are typically installed approximately a mile apart from one another (e.g., cellular towers in a cellular network). The wireless transport mechanisms and frequencies employed by typical licensed wireless systems limit both data transfer rates and range. As a result, the quality of service (voice quality and speed of data transfer) in licensed wireless systems is considerably inferior to the quality of service afforded by landline (wired) connections. Thus, the user of a licensed wireless system pays relatively high fees for relatively low quality service.

Landline (wired) connections are extensively deployed and generally perform at a lower cost with higher quality voice and higher speed data services. The problem with landline connections is that they constrain the mobility of a user. Traditionally, a physical connection to the landline was required.

In the past few years, the use of unlicensed wireless communication systems to facilitate mobile access to landline-based networks has seen rapid growth. For example, such unlicensed wireless systems may support wireless communication based on the IEEE 802.11a, b or g standards (WiFi), or the Bluetooth® standard. The mobility range associated with such systems is typically on the order of 100 meters or less. A typical unlicensed wireless communication system includes a base station comprising a wireless access point (AP) with a physical connection (e.g., coaxial, twisted pair, or optical cable) to a landline-based network. The AP has a RF transceiver to facilitate communication with a wireless handset that is operative within a modest distance of the AP, wherein the data transport rates supported by the WiFi and Bluetooth® standards are much higher than those supported by the aforementioned licensed wireless systems. Thus, this option provides higher quality services at a lower cost, but the services only extend a modest distance from the base station.

Currently, technology is being developed to integrate the use of licensed and unlicensed wireless systems in a seamless fashion, thus enabling a user to access, via a single handset, an unlicensed wireless system when within the range of such a system, while accessing a licensed wireless system when out of range of the unlicensed wireless system. The unlicensed wireless communication systems, however, require the use of dual-mode wireless transceivers to communicate with the licensed system over the licensed wireless frequencies and with the unlicensed system over the unlicensed wireless frequencies. The use of such dual-mode transceivers requires the service providers to upgrade the existing subscribers' transceivers which operate only on licensed wireless frequencies to dual-mode transceivers. Therefore, there is a need in the art to develop a system that provides the benefits of the systems described above, without the need for dual-mode transceivers.

### SUMMARY OF THE INVENTION

Some embodiments are implemented in a communication system that includes a first wireless communication system that includes a licensed wireless radio access network and a core network and a second wireless communications system that includes several unplanned and user deployed access points for establishing service regions of the second network using short-range licensed wireless frequencies and a network controller for communicatively coupling a user equipment (UE) operating in the service regions to the core network.

In some embodiments, the network controller can communicatively couple to the first wireless communications system through a UTRAN Iu interface. In some embodiments, an access point can communicatively couple to a user equipment using a short-range licensed wireless frequency.

Some embodiments provide a handing over method that determines, by a first access point, to handover the UE to a second access point. The first and the second access point are access points in the several unplanned and user deployed access points. The method sends a relocation required message from a first access point to the network controller. The relocation message includes a network controller identifier and a cell identifier. The method also receives, by the second access point, a relocation request message from the network controller. The method establishes, by the second access point, a connection from the second access point to the network controller. The method also receives, by the first access point, a relocation command message from the network controller. The first access point sends the relocation command message to the UE. The relocation command message is for causing the UE to handover to the second access point. The access points in the several unplanned and user deployed access points have the same location area identifier (LAI) value.

Some embodiments provide a cell updating method that receives, by a first access point, a cell update message from the UE. The method sends a cell update request message from the first access point to the network controller. The network controller sends the cell update request message to a second access point. The method also receives, by the first access point, a cell update response message from the network controller. The network controller receives the cell update response message from the second access point. The method sends a cell update confirm message from the first access point to the UE. The access points in the several access points have the same location area identifier (LAI) value. The first and the second access point are in the several unplanned and user deployed access points.

Some embodiments provide a method of distributing user equipment temporary identifiers to access points in a group. The temporary identifier is allocated to the UE by the core network. The UE is registered on the first access point. The method sends, by the first access point, a register update message to the network controller. The register update message includes a permanent identifier, a previous temporary identifier, and the temporary identifier that has been allocated to the UE by the core network. The network controller sends the register update message to a second access point for the second access point to update the previous temporary identifier with the temporary identifier. The permanent identifier, the previous temporary identifier, and said temporary identifier are associated with the UE. The first and the second access point are access points in the several unplanned and user deployed access points. The access points in the several unplanned and user deployed access points have the same location area identifier (LAI) value.

Some embodiments provide a method of managing user equipment identifiers that receives, by a access point, a radio resource control (RRC) connection request message from the UE. The method sends a RRC connection setup message that includes a first identifier from the access point to the UE. The first identifier is allocated to the UE by the access point. The method also sends a request message from the access point to the network controller. The request message includes a CM services request message and the first identifier. The network controller determines the first identifier is in use. The method generates a second identifier. The method also sends a mobility info message from the access point to the UE. The mobility info message includes the second identifier.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a 3G HNB system architecture of some embodiments.

FIG. 2 illustrates the protocol stack for transport of RANAP messages over the Iuh interface of some embodiments.

FIG. 3 illustrates the protocol architecture supporting the HNB Application Part (HNBAP) over the Iuh interface, in some embodiments.

FIG. 4 illustrates an enterprise 3G HNB system of some embodiments.

FIG. 5 illustrates TMSI allocation of some embodiments.

FIG. 6 illustrates a TMSI distribution method of some embodiments.

FIG. 7 illustrates a U-RNTI management method of some embodiments.

FIG. 8 illustrates a U-RNTI management method of some embodiments.

FIG. 9 illustrates handover from 3G HNB to UTRAN of some embodiments.

FIG. 10 illustrates handover from 3G HNB to GERAN of some embodiments.

FIG. 11 illustrates handover from 3G HNB to UTRAN of some embodiments

FIG. 12 illustrates inter-HNB CS handover of some embodiments.

FIG. 13 illustrates inter-HNB PS handover of some embodiments.

FIG. 14 illustrates inter-HNB CS+PS handover of some embodiments.

FIG. 15 illustrates cell update in the CELL_FACH state in some embodiments.

FIG. 16 illustrates cell update handling of some embodiments.

FIG. 17 illustrates a computer system with which some embodiments of the invention are implemented.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Throughout the following description, acronyms commonly used in the telecommunications industry for wireless services are utilized along with acronyms specific to the present invention. A table of acronyms used in this application is included in Section V.

Some embodiments are implemented in a communication system that includes a first wireless communication system and a second wireless communication system that includes a Home Node B (HNB) and a network controller that can communicatively couple the HNB to the first wireless communication system.

In some embodiments, the network controller can communicatively couple to the first wireless communication system through a UTRAN Iu interface. In some embodiments, the HNB can communicatively couple to a user equipment using a short-range licensed wireless frequency.

Some embodiments are implemented in a communication system that includes a first wireless communication system that includes a licensed wireless radio access network and a core network and a second wireless communications system that includes several unplanned and user deployed access points for establishing service regions of the second network using short-range licensed wireless frequencies and a network controller for communicatively coupling a user equipment (UE) operating in the service regions to the core network.

In some embodiments, the network controller can communicatively couple to the first wireless communications system through a UTRAN Iu interface. In some embodiments, an access point can communicatively couple to a user equipment using a short-range licensed wireless frequency.

Some embodiments provide a handing over method that determines, by a first access point, to handover the UE to a second access point. The first and the second access point are access points in the several unplanned and user deployed access points. The method sends a relocation required message from a first access point to the network controller. The method also receives, by the second access point, a relocation request message from the network controller. The method establishes, by the second access point, a connection from the second access point to the network controller. The method also receives, by the first access point, a relocation command message from the network controller. The first access point sends the relocation command message to the UE. The relocation command message is for causing the UE to handover to the second access point. The access points in the several unplanned and user deployed access points have the same location area identifier (LAI) value.

Some embodiments provide a cell updating method that receives, by a first access point, a cell update message from the UE. The method sends a cell update request message from the first access point to the network controller. The network controller sends the cell update request message to a second access point. The method also receives, by the first access point, a cell update response message from the network controller. The network controller receives the cell update response message from the second access point. The method sends a cell update confirm message from the first access point to the UE. The access points in the several access points have the same location area identifier (LAI) value. The first and the second access point are in the several unplanned and user deployed access points.

Some embodiments provide a method of distributing user equipment temporary identifiers to access points in a group. The temporary identifier is allocated to the UE by the core network. The UE is registered on the first access point. The method sends, by the first access point, a register update message to the network controller. The register update message includes a permanent identifier, a previous temporary identifier, and the temporary identifier that has been allocated to the UE by the core network. The network controller sends the register update message to a second access point for the second access point to update the previous temporary identifier with the temporary identifier. The permanent identifier, the previous temporary identifier, and said temporary identifier are associated with the UE. The first and the second access point are access points in the several unplanned and user deployed access points. The access points in the several unplanned and user deployed access points have the same location area identifier (LAI) value.

Some embodiments provide a method of managing user equipment identifiers that receives, by a access point, a radio resource control (RRC) connection request message from the UE. The method sends a RRC connection setup message that includes a first identifier from the access point to the UE. The first identifier is allocated to the UE by the access point. The method also sends a request message from the access point to the network controller. The request message includes a CM services request message and the first identifier. The network controller determines the first identifier is in use. The method generates a second identifier. The method also sends a mobility info message from the access point to the UE. The mobility info message includes the second identifier.

Several more detailed embodiments of the invention are described in sections below. Section I describes the system architecture of a HNB system. Next, Section II describes the protocol architecture of the HNB system. Section III presents the mobility management functions of the HNB system in some embodiments. Next, a description of a computer system with which some embodiments of the invention are implemented is provided in Section IV. Finally, Section V lists the definitions and abbreviations used.

### I. HNB SYSTEM ARCHITECTURE

### A. Enterprise HNB System Architecture

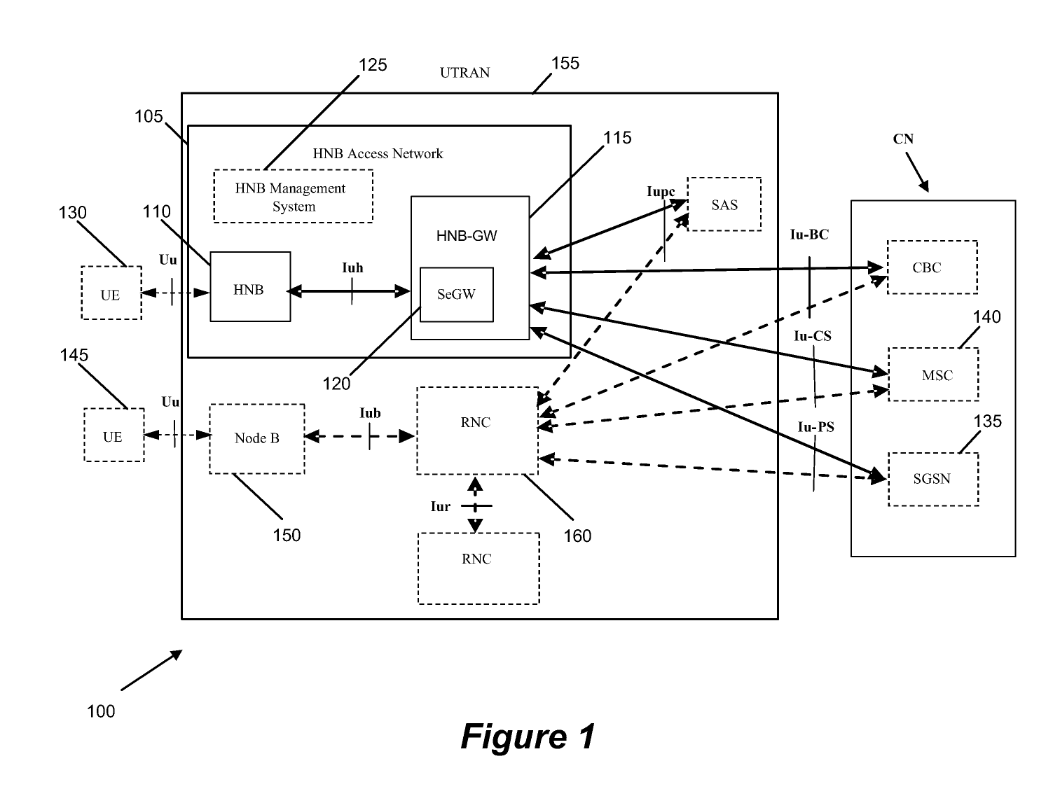

FIG. 1 shows an overview of the functional entities of a HNB system architecture that allow the Iu-based deployment of HNBs in UTRAN (Universal Mobile Telecommunication System (UMTS) Terrestrial Radio Access Network), in accordance with some embodiments. The figure shows a Home Node B (HNB) Access Network 105 that includes one or more HNBs (only one is shown for simplicity) 110, the HNB Gateway (HNB-GW) 115, the Security Gateway (SeGW) 120, and the HNB Management System 125. FIG. 1 also shows the Iuh interface in the HNB Access Network 105.

HNB system architecture 100 enables one or more user equipments (UEs) 130 (only one is shown for simplicity) to access a voice and data network via a Uu interface through which components of the licensed wireless core network (CN) are accessed. In some embodiments, a communication session through the interface includes voice services, data services, or both.

The mobile core network includes one or more Home Location Registers (HLRs) (not shown) and databases (not shown) for subscriber authentication and authorization. Once authorized, the UE 130 accesses the voice and data services of the mobile core network. In order to provide such services, the mobile core network includes a mobile switching center (MSC) 140 for providing access to the circuit switched services (e.g., voice and data). Packet switched services are provided for through a Serving GPRS (General Packet Radio Service) Support Node (SGSN) 135 in conjunction with a gateway such as the Gateway GPRS Support Node (GGSN) (not shown).

The SGSN 135 is typically responsible for delivering data packets from and to the GGSN and the UE 130 within the geographical service area of the SGSN 135. Additionally, the SGSN 135 performs functionality such as mobility management, storing user profiles, and storing location information. However, the actual interface from the mobile core network to various external data packet services networks (e.g., public Internet) is facilitated by the GGSN. As the data packets originating from the UE 130 typically are not structured in the format with which to access the external data networks, it is the role of the GGSN to act as the gateway into such packet services networks. In this manner, the GGSN provides addressing for data packets passing to and from the UE 130 and the external packet services networks (not shown). Moreover, as the UE 130 of a licensed wireless network traverses multiple service regions and thus multiple SGSNs, it is the role of the GGSN to provide a static gateway into the external data networks.

In the illustrated embodiment, components common to a UTRAN based cellular network that includes multiple base stations referred to as Node Bs 150 (of which only one is shown for simplicity) that facilitate wireless communication services for various UE 145 via respective licensed radio links (e.g., radio links employing radio frequencies within a licensed bandwidth). However, one of ordinary skill in the art will recognize that in some embodiments, the licensed wireless network includes other components such the GSM/EDGE Radio Access Network (GERAN).

The licensed wireless channel comprises any licensed wireless service having a defined UTRAN or GERAN interface protocol (e.g., Iu-cs and Iu-ps interfaces for UTRAN or A and Gb interfaces for GERAN) for a voice/data network. The UTRAN 155 typically includes at least one Node B 150 and a Radio Network Controller (RNC) 160 for managing the set of Node Bs 150. Typically, the multiple Node Bs 150 are configured in a cellular configuration (one per each cell) that covers a wide service area. A licensed wireless cell is sometimes referred to as a macro cell which is a logical term used to reference, e.g., the UMTS radio cell (i.e., 3G cell) under Node-B/RNC which is used to provide coverage typically in the range of tens of kilometers. Also, the UTRAN or GERAN is sometimes referred to as a macro network.

Each RNC 160 communicates with components of the core network through a standard radio network controller interface such as the Iu-cs and Iu-ps interfaces depicted in FIG. 1. For example, a RNC 160 communicates with MSC 140 via the UTRAN Iu-cs interface for circuit switched services. Additionally, the RNC 160 communicates with SGSN 135 via the UTRAN Iu-ps interface for packet switched services through GGSN. Moreover, one of ordinary skill in the art will recognize that in some embodiments, other networks with other standard interfaces apply. For example, the RNC 160 in a GERAN network is replaced with a Base Station Controller (BSC) that communicates with the MSC 140 via an A interface for the circuit switched services and the BSC communicates with the SGSN 135 via a Gb interface of the GERAN network for packet switched services.

In some embodiments, the UE 130 uses the services of the mobile core network via a communication network facilitated by the Uu interface and a Home Node B Gateway (HNB-GW) 115.

In some embodiments, the voice and data services over the Uu interface are facilitated via an access point communicatively coupled to a broadband IP network. In some embodiments, the access point is a Home Node B (also referred to as Home Node B access point, Femtocell access point, or FAP) 110 communicatively coupled to a broadband IP network. In some embodiments, the HNB-GW 115, HNB 110, UE 130, and the area covered by the HNB are collectively referred to as a HNB system. A HNB spans a smaller area (typically few tens of meters) than a macro cell. In other words, the HNB is a micro cell that has a range that is 100, 1000, or more times less than a macro cell. In case of the HNB system, the UE 130 connects to the core network through a short-range licensed wireless network created by the HNB 110. Signals from the HNB 110 are then transmitted over the broadband IP network.

The signaling from the UE 130 is passed over the Uu and Iuh interface to the HNB-GW 115. After the HNB-GW 115 performs authentication and authorization of the subscriber, the HNB-GW 115 communicates with components of the mobile core network using a radio network controller interface that is the same or similar to the radio network controller interface of the UTRAN described above, and includes a UTRAN Iu-cs interface for circuit switched services and a UTRAN Iu-ps interface for packet switched services (e.g., GPRS). In this manner, the HNB-GW 115 uses the same or similar interfaces to the mobile core network as a UTRAN Radio Access Network Subsystem (e.g., the Node B 150 and RNC 160).

### B. Functional Entities

1. User Equipment (UE)

The User Equipment (UE) 130, also referred to as mobile station (MS), is a standard 3G handset device operating over licensed spectrum of the provider.

2. Broadband IP Network

In some embodiments, HNB 110 and HNB-GW 115 are connected to a broadband IP network. The Broadband IP Network represents all the elements that collectively, support IP connectivity between the HNB-GW SeGW 120 function and the HNB 110. This includes: (1) Other Customer premise equipment (e.g., DSL/cable modem, WLAN switch, residential gateways/routers, switches, hubs, WLAN access points), (2) Network systems specific to the broadband access technology (e.g., DSLAM or CMTS), (3) ISP IP network systems (edge routers, core routers, firewalls), (4) Wireless service provider (WSP) IP network systems (edge routers, core routers, firewalls), and (5) Network address translation (NAT) functions, either standalone or integrated into one or more of the above systems.

3. Home Node B (HNB)

The HNB 110 is a licensed access point which offers a standard radio interface (Uu) for UE connectivity. In some embodiments, the HNB 110 is equipped with either a standard 3G Universal Subscriber Identity Module (USIM) or a 2G Subscriber Identity Module (SIM).

The HNB 110 is installed at the customer premise and includes a 3G radio that enables existing mobile phones (or UEs) to connect to the HNB 110 in the same manner as mobile phones access the macro 3G network. The HNB 110 also includes radio management capabilities and Node B functionality.

HNB 110 enables UEs, such as standard mobile stations and wireless enabled computers, to receive low cost services using a short-range licensed wireless communication sessions through HNB 110.

The Iu-h interface between the HNB 110 and HNB-GW 115 provides a secure, reliable communications link between the network elements. The Iu-h interface also supports a device management link to enable highly scalable ad-hoc deployments and flexible access controls. Therefore, deployment of HNBs can be ad-hoc and unplanned (or with much less planning compared to the deployment of a Node B by a service provider).

In accordance with some embodiments, the HNB 110 is located in a fixed structure, such as a home or an office building. In some embodiments, the service area of the HNB 110 includes an indoor portion of a building, although it may be understood that the service area may include an outdoor portion of a building or campus.

a. HNB Groups

A HNB Group is a set of HNBs (e.g., from 2 to 20 HNBs) which is assigned the same HNB Group ID (also referred to as Closed Subscriber Group ID (CSG-ID) or Femtocell Group ID (FG-ID)) by the HNB Management System 125. In some embodiments, the HNBs in the same group may share the same broadcast location area identifier (LAI) (i.e., the LAI that is locally assigned by the HNB). Each HNB can be a member of only one HNB Group. In some embodiments, the HNB-GW applies special processing in the case of UEs served by HNBs in a HNB Group.

4. Home Node B Gateway (HNB-GW)

The HNB-GW 115, also referred to as IP network controller (INC), appears to the core network as a UTRAN Radio Network Controller (RNC). The HNB-GW 115 includes a Security Gateway (SeGW) 120.

The HNB-GW is installed at the mobile service provider's premise (e.g., at a network equipment office), providing security, aggregation and core network interfaces for HNBs deployed over the IP access network.

The SeGW 120 terminates secure access tunnels from the HNB 110, providing mutual authentication, encryption and data integrity for signaling, voice and data traffic. The SeGW 120 is required to support EAP-SIM and EAP-AKA authentication for the HNB 110.

5. Other Components

The HNB Management System 125, also referred to as Access Point Management System (AMS), is used to manage a large number of HNBs 110 including configuration, failure management, diagnostics, monitoring and software upgrades. The access to HNB Management System 125 functionality is provided over secure interface via the HNB-GW SeGW 120.

The SGSN 135 provides packet switched (PS) services via the standard Iu-ps interface. The SGSN 135 connects to the HNB-GW for signaling and to the SeGW 120 for PS data. The 3G MSC 140 provides a standard Iu-cs interface towards the HNB-GW 115. The MSC 140 may be split up into a MSS (MSC Server) (not shown) for Iu-cs based signaling and MGW (not shown) for the bearer path.

The Authorization, Authentication, and Accounting (AAA) server (not shown) communicates with the SeGW 120 and supports the EAP-AKA and EAP-SIM procedures used in IKEv2 over the Wm interface and includes a MAP interface to the HLR/AuC. The AAA server is used to authenticate the HNB 110 when it sets up a secure tunnel. Some embodiments require only a subset of the Wm functionalities for the system application. In these embodiments, as a minimum the HNB-GW-SeGW supports the Wm authentication procedures.

Some embodiments of the above mentioned devices, such as the user equipment, HNB, or HNB-GW, include electronic components, such as microprocessors and memory (not shown), that store computer program instructions (such as instructions for executing wireless protocols for managing voice and data services) in a machine-readable or computer-readable medium as further described below in the section labeled “Computer System”. Examples of machine-readable media or computer-readable media include, but are not limited to magnetic media such as hard disks, memory modules, magnetic tape, optical media such as CD-ROMS and holographic devices, magneto-optical media such as optical disks, and hardware devices that are specially configured to store and execute program code, such as application specific integrated circuits (ASICs), programmable logic devices (PLDs), ROM, and RAM devices. Examples of computer programs or computer code include machine code, such as produced by a compiler, and files including higher-level code that are executed by a computer, an electronic component, or a microprocessor using an interpreter.

### II. HNB PROTOCOL ARCHITECTURE

### A. Transport of RANAP Messages Over the Iuh Interface

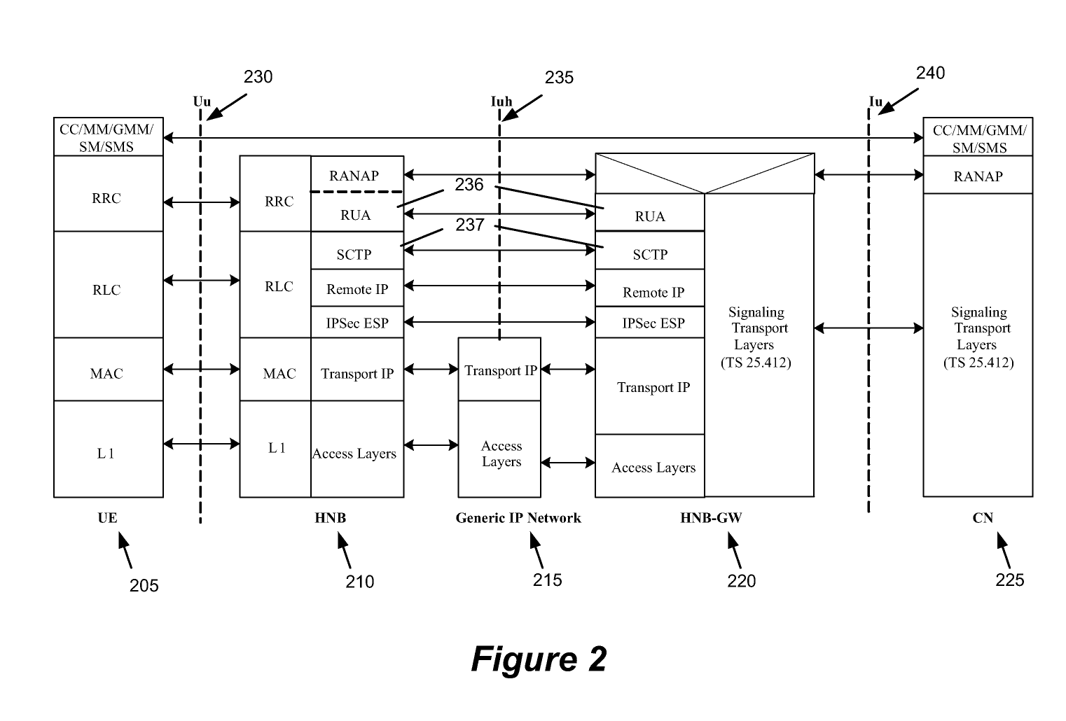

FIG. 2 illustrates a protocol stack for transport of RANAP messages over the Iuh interface according to some embodiments. The figure shows different protocol layers for the UE 205, HNB 210, Generic IP Network 215, HNB-GW 220, and CN 225. FIG. 2 also shows the three interfaces Uu 230, Iuh 235, and Iu 240.

In some embodiments, in order to provide a separation of RANAP and HNB Application Part (HNBAP) at transport layer, the encapsulation of RANAP is achieved via a lightweight adaptation layer (RUA 236) over a reliable transport layer such as Stream Control Transmission Protocol (SCTP) 237 as shown in FIG. 2. The key function of this adaptation layer is to provide similar functionality of transferring RANAP messages as defined in “UTRAN Iu interface Radio Access Network Application Part (RANAP) signaling,” 3GPP TS 25.413, over the Iuh interface 235. In some embodiments, other reliable transport layers such as Transmission Control Protocol (TCP) (not shown) are used instead of the SCTP 237.

### B. HNB Application Part (HNBAP) Protocol Architecture

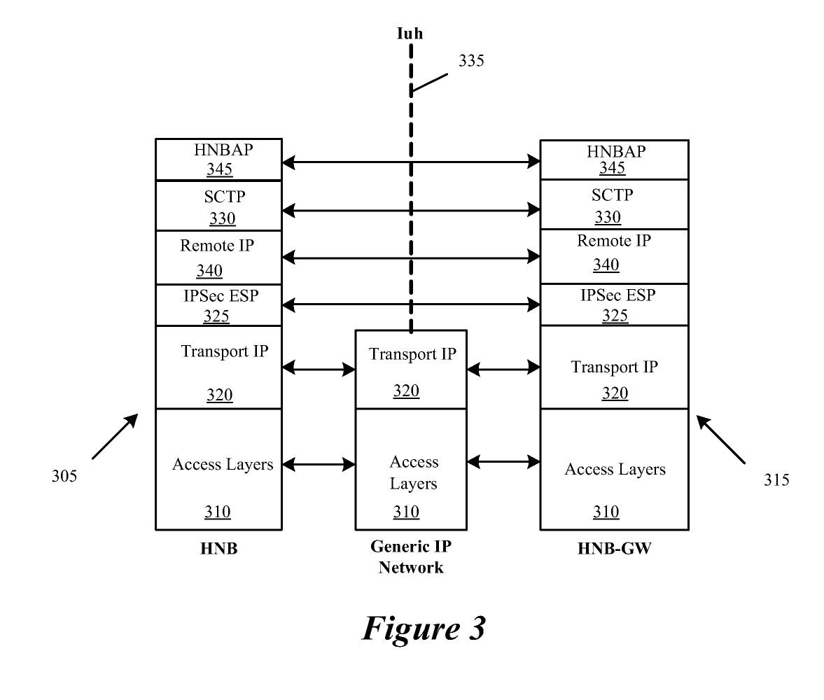

The HNBAP is a lightweight protocol over the Iuh interface between the HNB and the HNB-GW. The HNBAP protocol architecture supports management functions between the HNB and HNB-GW including, but not limited to, the management of the underlying transport (i.e., the SCTP connection) and HNB and UE registration procedures. FIG. 3 illustrates the HNBAP protocol architecture in accordance with some embodiments. This figure illustrates HNBAP protocol stacks of each of the HNB 305 and the HNB-GW 315. As shown, the HNBAP protocol stacks include (1) access layers 310, (2) transport IP layer 320, (3) IP Security (IPSec) ESP layer 325, (4) remote IP layer 340, (5) SCTP layer 330, and (6) a HNBAP protocol layer 345.

The underlying Access Layers 310 and “Transport IP” layer 320 (i.e., the “outer” IP layer associated with IPSec tunnel mode) provide the generic connectivity between the HNB 305 and the HNB-GW 315. The IPSec layer 325 operates in tunnel mode and provides encryption and data integrity for communications and data that are passed using the upper layers (330, 340, and 345).

SCTP 330 provides reliable transport between the HNB 305 and the HNB-GW 315. SCTP 330 is transported using the “Remote IP” layer 340 (i.e., the “inner” IP layer associated with IPSec tunnel mode). In some embodiments, the SCTP 330 establishes a single SCTP association between the HNB 305 and HNB-GW 315. The same SCTP association is used for the transport of both the HNBAP messages as well as the RANAP messages (using RUA protocol) over the Iuh interface 335. The SCTP Payload Protocol Identifier (PPI) value is used to identify the protocol being transported in the SCTP data chunk (e.g., HNBAP or RUA). The PPI value used for HNBAP transport is coordinated between the HNB 305 and the HNB-GW 315 (e.g., the HNBAP PPI value should be registered with the Internet Assigned Numbers Authority (IANA)). Each SCTP association includes a number of “streams” which are used to support multiple flows across the Iuh interface 335. In some embodiments, a dedicated SCTP stream (i.e., stream id 0 of the underlying SCTP transport association) is used for the transport of HNBAP messages across the Iuh interface.

It should be apparent to one of ordinary skill in the art that other reliable transport protocol layers may be used instead of SCTP 330 to facilitate reliable transport of communications and data between the HNB 305 and the HNB-GW 315. For instance, some embodiments use TCP for reliably transporting messages between the HNB 305 and the HNB-GW 315.

In some embodiments, the HNBAP protocol 345 provides a resource management layer or equivalent functional layer capable of registration of the HNB and UE with the HNB-GW, registration updates with the HNB-GW, and support for the identification of the HNB being used for HNB access. It should be apparent to one of ordinary skill in the art that the HNBAP protocol layer of some embodiments implements additional resource management functionality and that the above enumerated list is an exemplary set of such functionality.

### III. MOBILITY MANAGEMENT

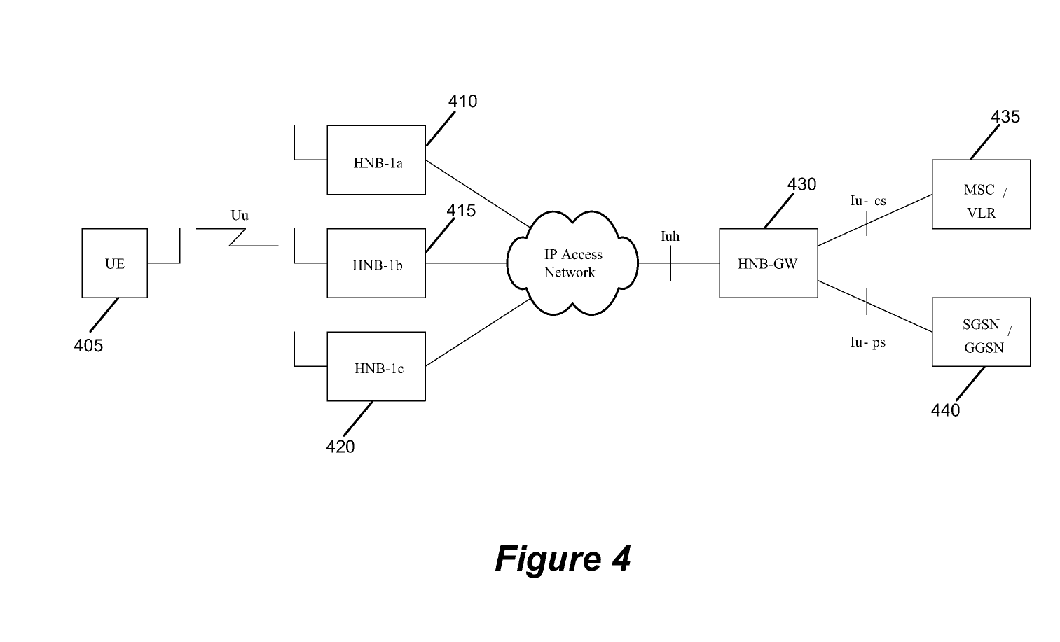

In some embodiments, the architecture illustrated in FIG. 1 supports enterprise HNB systems. An example of an enterprise HNB System is illustrated in FIG. 4.

The User Equipment (UE 405) device moves between Home Node B (HNB) systems that are part of a HNB Group (i.e., HNB-1a 410, HNB-1b 415, and HNB-1c 420). In some embodiments, the members of the HNB Group broadcast the same Location Area ID (LAI). Therefore, the UE 405 moves (i.e., re-select while in idle mode) between members of the HNB Group without notifying the network.

Thus, it is not generally possible to immediately detect a UE's mobility from one HNB to another HNB when the two HNBs are in the same HNB Group. If the UE 405 cell selection process selects a neighboring HNB in the same HNB Group, the UE 405 camps on the neighboring HNB without any explicit messaging. Detection of the UE 405 movement is performed when the UE 405 requests service via the new HNB.

The HNBs are connected to a HNB Gateway (HNB-GW 430) which provides the interface to the core network elements via standard Iu interfaces (i.e., the Iu-cs interface to the MSC/VLR 435 and the Iu-ps interface to the SGSN/GGSN 440).

A. UE Addressing

The International Mobile Subscriber Identity (IMSI) associated with the SIM or USIM in the UE is provided by the HNB to the HNB-GW when it registers a specific UE attempting to camp on the HNB. The HNB-GW maintains a record for each registered UE. For instance, IMSI is used by the HNB-GW to find the appropriate UE record when the HNB-GW receives a RANAP PAGING message.

1. User Identity Confidentiality

User identity confidentiality is an important security feature in cellular networks as specified in “3G Security Architecture,” 3GPP TS 33.102, some of which are explained below. The following security features are related to user identity confidentiality. User identity confidentiality is the property that the permanent user identity (IMSI) of a user to whom a services is delivered cannot be eavesdropped on the radio access link. User location confidentiality is the property that the presence or the arrival of a user in a certain area cannot be determined by eavesdropping on the radio access link. User untraceability is the property that an intruder cannot deduce whether different services are delivered to the same user by eavesdropping on the radio access link.

To achieve these objectives, the user is normally identified by a temporary identity by which he is known by the visited serving network. To avoid user traceability, which leads to the compromise of user identity confidentiality, the user is not to be identified for a long period by means of the same temporary identity. To achieve these security features, some embodiments require that any signaling or user data that might reveal the user's identity is ciphered on the radio access link.

a. Identification by Temporary Identities

This mechanism allows the identification of a user on the radio access link by means of a temporary mobile subscriber identity (TMSI) or packet TMSI (P-TMSI) (TMSI/P-TMSI). A TMSI/P-TMSI has local significance in the location area or routing area in which the user is registered. Outside that area the user is accompanied by an appropriate Location Area Identification (LAI) or Routing Area Identification (RAI) in order to avoid ambiguities. The association between the permanent and temporary user identities is kept by the Visited Location Register (VLR/SGSN) in which the user is registered.

The TMSI/P-TMSI, when available, is normally used to identify the user on the radio access path, for instance in paging requests, location update requests, attach requests, service requests, connection re-establishment requests and detach requests.

b. TMSI Reallocation Procedure

The purpose of the mechanism described in this subsection is to allocate a new TMSI/LAI pair to a user by which he may subsequently be identified on the radio access link. According to some embodiments, the procedure is performed after the initiation of ciphering.

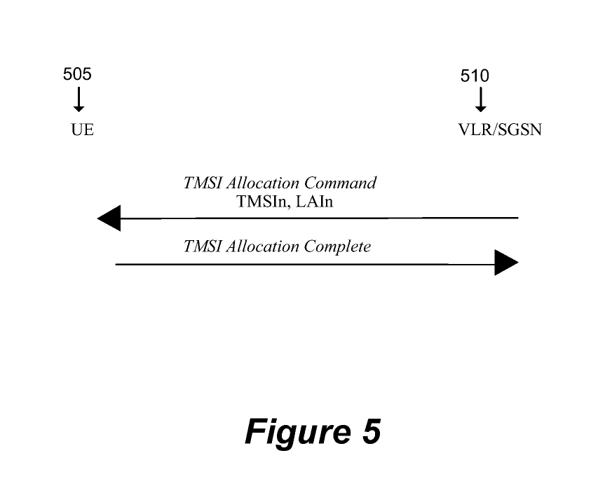

The allocation of a temporary identity in some embodiments is illustrated in FIG. 5. The allocation of a temporary identity is initiated by the VLR 510. The VLR 510 generates a new temporary identity (TMSIn) and stores the association of TMSIn and the permanent identity IMSI in its database. In some embodiments, the TMSI is unpredictable. The VLR 510 then sends the TMSIn and (if necessary) the new location area identity LAIn to the user (UE 505).

Upon receipt the user (UE 505) stores TMSIn and automatically removes the association with any previously allocated TMSI. The user (UE 505) sends an acknowledgement back to the VLR 510. Upon receipt of the acknowledgement the VLR 510 removes the association with the old temporary identity TMSIo and the IMSI (if there was any) from its database.

As described in above excerpts from 3GPP TS 33.102, the MSC/VLR and SGSN allocate temporary identifiers to the UE while operating within the HNB Group. The relationship between the temporary identifier (e.g., TMSI) and the permanent identity must be known in the serving HNB, to avoid requiring the HNB to request the permanent identity (i.e., IMSI) each time the UE requests service. The HNB and HNB-GW must know the permanent identity of the UE in order to apply appropriate service access control (e.g., only certain UEs are allowed to use the HNB).

The requirement to keep track of the TMSI assigned to each UE dictates that, for example, the HNB monitor the TMSI allocation exchanges between the core network and the UE and internally store the IMSI/TMSI mapping. The problem is that the other HNBs in the group are not aware of the dynamic TMSI/IMSI relationship. For example, when a UE 405 moves from HNB-1a 410 to HNB-1b 415 and attempts to access service using the TMSI allocated while the UE 405 was served by HNB-1a 410, HNB-1b 415 must perform an identity request operation to determine the IMSI of the UE 405.

c. Description of TMSI Distribution Method

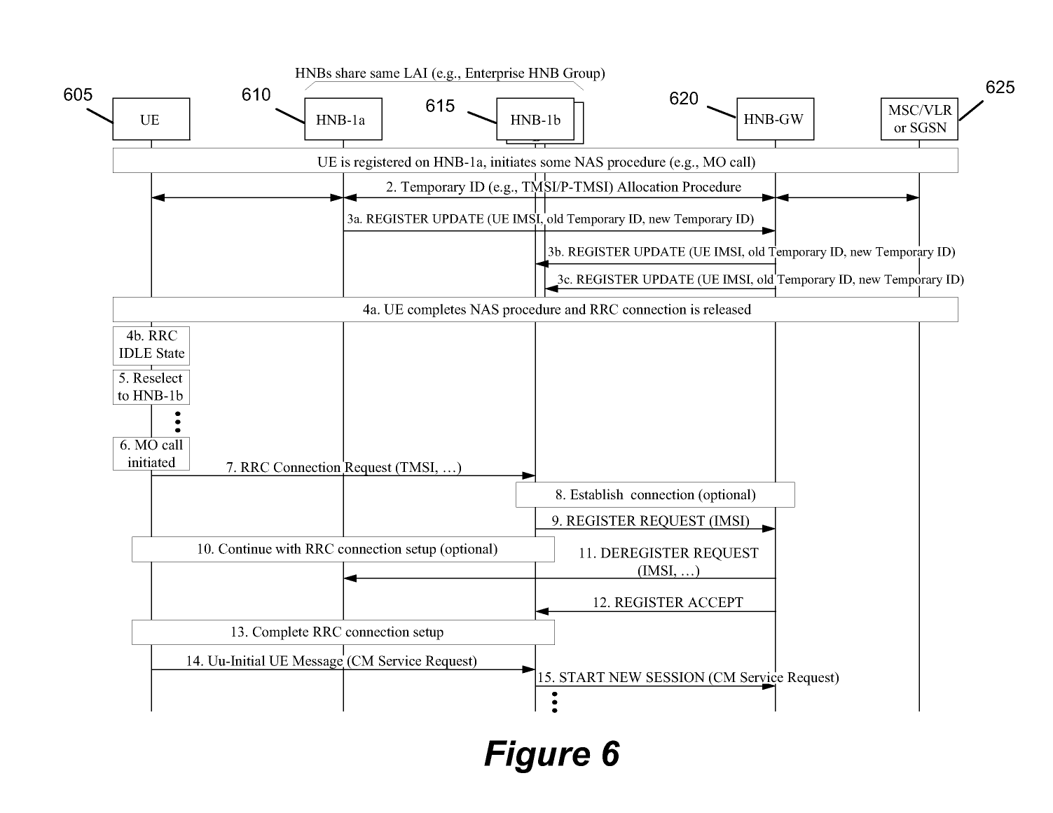

A novel TMSI distribution method is disclosed to address the problem described in the preceding paragraph. One embodiment of the method is illustrated in FIG. 6.

As shown, the UE 605 is registered (in step 1) on HNB-1a 610 and initiates some non-access stratum (NAS) procedure, e.g., a mobile-originated call. During the course of the call, the VLR 625 allocates (in step 2) a new TMSI to the UE 605. HNB-1a 610 monitors this NAS exchange between the UE 605 and the VLR 625 and internally stores the new IMSI/TMSI mapping.

HNB-1a 610 sends the new IMSI/TMSI mapping (in step 3a) to the HNB-GW 620 in a REGISTER UPDATE message. The HNB-GW 620 relays (in steps 3b and 3c) the new IMSI/TMSI mapping to all the other HNBs in the group in separate REGISTER UPDATE messages (e.g., to HNB-1b 615 and HNB-1c 420).

The UE 605 completes (in step 4a) the NAS procedure, the signaling connection between the UE 605 and the network is released, and the UE 605 returns (in step 4b) to the RRC Idle state. While idle, the UE 605 moves location and re-selects (in step 5) to HNB-1b 615. As described above, the UE 605 does not inform HNB-1b 615 that the UE 605 is now camping on the HNB-1b 615 cell.

Sometime later, the UE 605 initiates (in step 6) a mobile-originated call (for example). Alternatively, in a mobile-terminated scenario, the HNB-GW sends a Paging message to all HNBs in the group, each HNB pages the UE, and the UE that recognizes the TMSI that is included in the page will respond via one of the HNBs per steps 7-onward.

The UE 605 sends (in step 7) a Radio Resource Control (RRC) Connection Request message to HNB-1b 615, including the TMSI as the UE identifier. HNB-1b 615 looks up the TMSI-to-IMSI mapping which was received from the HNB-GW 620 in step 3b. In some embodiments, the RRC Connection Request message is a Uu-RRC Connection Request message.

When there are no connections between HNB-1b 615 and HNB-GW 620, HNB-1b establishes (in step 8) a signaling connection with HNB-GW 620. In some embodiments, this connection uses a reliable transport protocol such as SCTP. In some embodiments, UE 605 uses a shared signaling connection that was already established between HNB-1b 615 and HNB-GW 620. In other embodiments, HNB-1b 615 establishes a dedicated signaling connection for each UE 605 communication.

HNB-1b 615 sends (in step 9) a REGISTER REQUEST message to the HNB-GW 620, including the IMSI identifier of the UE 605. In some embodiments, HNB-1b 615 continues (in step 10) the RRC connection setup procedure with the UE 605. In some embodiments, HNB-1b 615 waits for an indication of registration acceptance from the HNB-GW 620.

The HNB-GW 620 sends (in step 11) a DEREGISTER message to the previous serving HNB-1a 610, indicating that the cause for the deregistration is that the UE 605 has registered on another HNB. The HNB-GW 620 sends (in step 12) a REGISTER ACCEPT message to the HNB-1b 615, indicating that service may be provided to the UE.

HNB-1b 615 completes (in step 13) the RRC connection setup procedure with the UE 605 (if not already completed). The UE 605 sends (in step 14) the “Initial UE Message” message to HNB-1b 615, including the Connection Management (CM) Service Request message. In some embodiments, the Initial UE Message is a Uu-Initial UE Message. HNB-1b 615 sends (in step 15) a START NEW SESSION message to the HNB-GW 620, including the CM Service Request message and the MO call proceeds.

In an alternative embodiment, the HNB-GW 620 monitors the TMSI/P-TMSI allocation procedure between the core network and the UE 605 (i.e., step 2 in FIG. 6) and sends a REGISTER UPDATE message to all HNBs in the group, informing them of the new TMSI-to-IMSI mapping. The embodiment described in FIG. 6 distributes the task of TMSI/P-TMSI allocation monitoring among the HNBs, rather than centralizing it in the HNB-GW 620. The alternative approach increases the required transaction processing capacity of the HNB-GW 620.

2. Management of U-RNTI

The UTRAN Radio Network Temporary Identifier (U-RNTI) is used as a UE identifier for the first cell access (at cell change) when a RRC connection exists for the UE and for UTRAN originated paging including associated response messages. The 32-bit U-RNTI is composed of: (1) RNC-ID (typically a 12-bit value), and (2) Serving RNC RNTI (S-RNTI) (typically a 20-bit value). In a typical macro UTRAN network, the RNC allocates U-RNTI values so that a unique U-RNTI is assigned to each UE with an active RRC connection.

If the UE is in the RRC Connected state, the HNB is assumed to assign a U-RNTI value to the UE during the RRC connection establishment process, which typically occurs before the HNB contacts the HNB-GW in association with the session.

The following problems occur in management of U-RNTIs. If the HNBs share the RNC-ID that is assigned to the HNB-GW and the assigned U-RNTI value must be unique to the UE, there is a need to coordinate the U-RNTI allocation among the HNBs that connect to a given HNB-GW. Static partitioning of the S-RNTI space introduces a management burden and restricts the scale of the HNB-GW/HNB system. For example, the 20-bit S-RNTI space could be divided among 65535 HNBs (16 bits), each allocated 16 S-RNTI values (4 bits).

An additional problem is that the UE uses the U-RNTI value that it has been assigned when it re-selects to a new cell and performs the Cell Update procedure in the RRC Connected state. If the new HNB (or HNB-GW) is not aware of the permanent identity (i.e., IMSI) associated with the U-RNTI, it may be required to request the permanent identity during the Cell Update procedure, exposing the permanent identity over the air (i.e., a breach of identity confidentiality). The HNB and HNB-GW must know the permanent identity of the UE to (a) apply appropriate service access control (e.g., only certain UEs may be allowed to use the HNB), and (b) to allow the RRC connection and other allocated resources to be “handed over” from the old HNB to the new HNB.

These issues (and especially the Cell Update issue) are of particular relevance in an Enterprise HNB system, but also apply for non-enterprise (e.g., residential) HNB applications where there is a need to ensure that the U-RNTI allocated to each UE is unique and a UE may move from one HNB to another, where both HNBs are served by the same HNB-GW.

a. U-RNTI Management Method

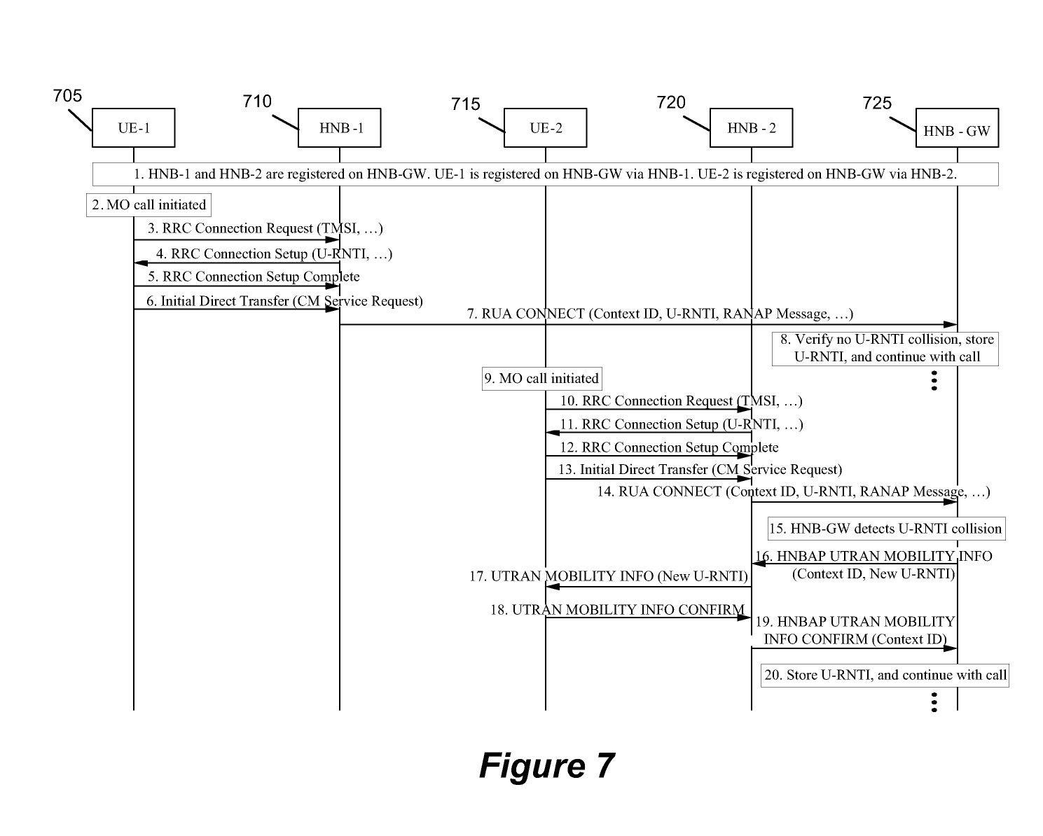

A novel U-RNTI Management method is disclosed to address the problems described above. One embodiment of the method is illustrated in FIG. 7.

As shown, HNB-1 710 and HNB-2 720 are registered (in step 1) on the HNB-GW 725. UE-1 705 is registered (in step 1) on HNB-GW 725 via HNB-1 710. UE-2 715 is registered (in step 1) on HNB-GW 725 via HNB-2 720.

The user of UE-1 705 initiates (in step 2) a mobile-originated call (for example). Similarly, UE-1 may receive a mobile terminated call, as described in conjunction with step 6 of FIG. 6, above. The RRC connection establishment procedure is executed (in steps 3-5). HNB-1 710 allocates (in step 4) a U-RNTI to the UE-1 705 consisting of the RNC-ID associated with the HNB-GW 725 (provided to HNB-1 710 during HNB registration on the HNB-GW 725) and a randomly-assigned S-RNTI value. In some embodiments, the messages in steps 3-5 are Uu-RRC Connection Request, Uu-RRC Connection Setup, and Uu-RRC Connection Setup Complete messages, respectively.

UE-1 705 sends (in step 6) the Initial Direct Transfer message to HNB-1 710 including the CM Service Request message. In some embodiments, the message in step 6 is a Uu-Initial Direct Transfer message. In some embodiments, the message in step 6 is an RRC-Initial Direct Transfer message. In some embodiments, HNB-1 710 sends (in step 7) a RUA CONNECT message to the HNB-GW 725 and includes the allocated U-RNTI value and the CM Service Request message received from the UE-1 705. In some embodiments, HNB-1 710 sends (in step 7) a START NEW SESSION message (not shown) to the HNB-GW 725 and includes the allocated U-RNTI value and the CM Service Request message received from the UE-1 705.

In some embodiments, the HNB-GW 725 verifies (in step 8) that the allocated U-RNTI value is not otherwise in use, stores the U-RNTI value with the associated UE context ID and the call continues per normal. In some embodiments, the HNB-GW 725 verifies (in step 8) that the allocated U-RNTI value is not otherwise in use, stores the U-RNTI value with the associated IMSI and the call continues per normal.

Sometime later, the user of UE-2 715 initiates a mobile-originated call (for example). Steps 10-14 are performed same as steps 3-6, above. The HNB-GW 725 determines (in step 15) that the allocated U-RNTI value is already in use.

The HNB-GW 725 selects an unused U-RNTI value and sends (in step 16) the New U-RNTI value to HNB-2 720 in a UTRAN MOBILITY INFO message. In some embodiments, the UTRAN MOBILITY INFO message is a HNBAP UTRAN MOBILITY INFO message. In some embodiment, the UTRAN MOBILITY INFO message also includes the UE context ID. HNB-2 720 sends (in step 17) the New U-RNTI value to UE-2 715 in the UTRAN MOBILITY INFO message. In some embodiments, this UTRAN MOBILITY INFO message is an RRC UTRAN MOBILITY INFO message.

Next, UE-2 715 stores the new U-RNTI value and sends (in step 18) a confirmation message to HNB-2 720. In some embodiments, the confirmation message is a UTRAN MOBILITY INFO CONFIRM message. In some embodiments, the confirmation message is an RRC UTRAN MOBILITY INFO CONFIRM message. HNB-2 720 confirms (in step 19) the new U-RNTI assignment to the HNB-GW 725 by sending a UTRAN MOBILITY INFO CONFIRM message. In some embodiments, the UTRAN MOBILITY INFO CONFIRM message is a HNBAP UTRAN MOBILITY INFO CONFIRM message. In some embodiments, the MOBILITY INFO CONFIRM message includes the UE context ID. In some embodiments, the HNB-GW 725 stores (in step 20) the U-RNTI value with the associated IMSI and the call continues per normal. In some embodiments, the HNB-GW 725 stores (in step 20) the U-RNTI value with the associated UE context ID and the call continues per normal.

In an alternative embodiment, rather than the HNBs randomly choosing a U-RNTI value and the HNB-GW 725 performing U-RNTI selection conflict detection and resolution, as described above, the U-RNTI allocation mechanism may be as described in the following paragraph.

The HNB provides the maximum number of active UEs supported by the HNB (i.e., maximum number of RRC connections) to the HNB-GW 725 during HNB registration (i.e., in a “HNB REGISTER REQUEST” message sent from the HNB to the HNB-GW 725). The HNB-GW 725 utilizes this information to dynamically allocate the appropriate U-RNTI range to the registering HNB. The HNB still includes the selected U-RNTI value in the “START NEW SESSION” message (as shown in steps 7 and 14 in FIG. 7) and the HNB-GW 725 still stores the selected value, but the HNB-GW 725 is not required to detect and resolve “U-RNTI collisions” (i.e., the selection of the same U-RNTI value by multiple HNBs).

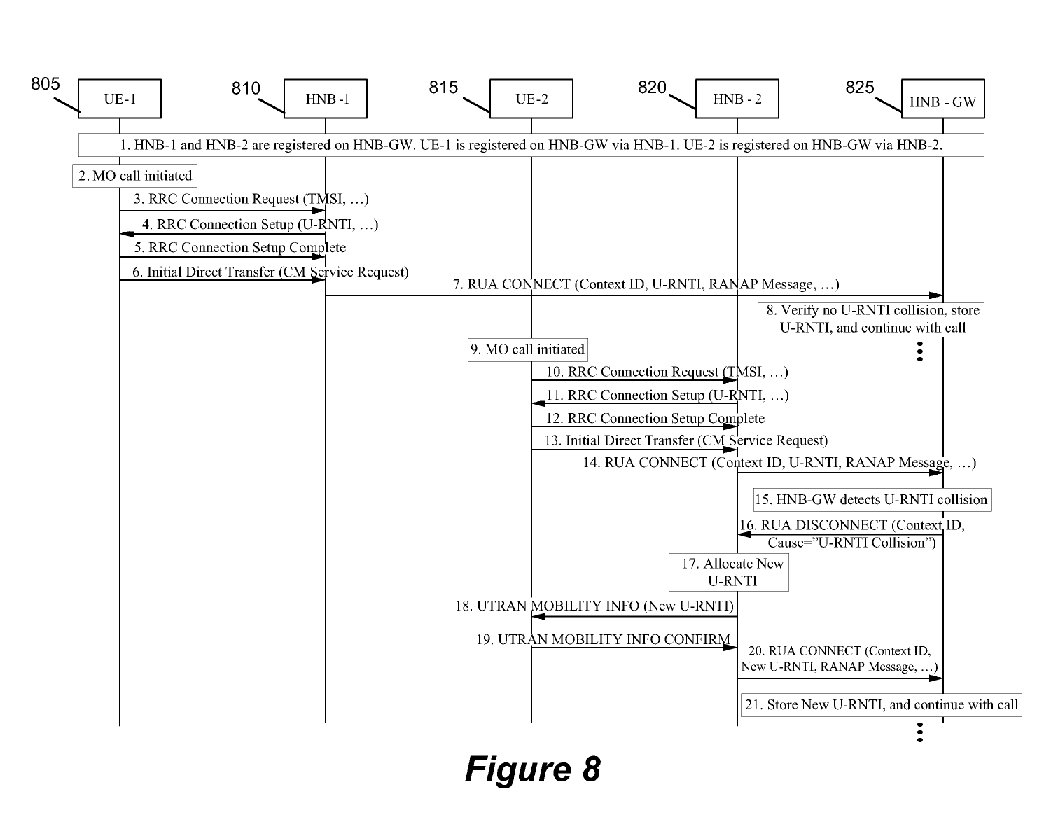

FIG. 8 illustrates an alternative embodiment. In this mechanism, the allocation of U-RNTI is completely within each HNB and the HNB-GW's role is only to detect and indicate U-RNTI collisions to the HNB.

As shown, HNB-1 810 and HNB-2 820 are registered (in step 1) on the HNB-GW 825. UE-1 805 is registered (in step 1) on HNB-GW 825 via HNB-1 810. UE-2 815 is registered (in step 1) on HNB-GW 825 via HNB-2 820.

The user of UE-1 805 initiates (in step 2) a mobile-originated call (for example). Similarly, UE-1 may receive a mobile terminated call, as described in conjunction with step 6 of FIG. 6, above. The RRC connection establishment procedure is executed (in steps 3-5). In some embodiments, the messages in steps 3-5 are Uu-RRC Connection Request, Uu-RRC Connection Setup, and Uu-RRC Connection Setup Complete messages, respectively. In step 4, HNB-1 810 allocates a U-RNTI to the UE-1 805 consisting of the RNC-ID associated with the HNB-GW 825 (provided to HNB-1 810 during HNB registration on the HNB-GW 825) and a randomly-assigned S-RNTI value.

UE-1 805 sends (in step 6) the Initial Direct Transfer message to HNB-1 810 including the CM Service Request message. In some embodiments, the message in step 6 is a Uu-Initial Direct Transfer message. In some embodiments, the message in step 6 is an RRC Initial Direct Transfer message. HNB-1 810 sends (in step 7) a RUA CONNECT message to the HNB-GW 825 and includes the allocated U-RNTI value and the CM Service Request message received from the UE-1 805. The HNB-GW 825 verifies (in step 8) that the allocated U-RNTI value is not otherwise in use, stores the U-RNTI value with the associated UE context ID and the call continues per normal.

Sometime later, the user of UE-2 815 initiates (in step 9) a mobile-originated call (for example). Steps 10-14 are performed same as steps 3-6, above. The HNB-GW 825 determines (in step 15) that the allocated U-RNTI value is already in use. The HNB-GW 825 sends (in step 16) a RUA DISCONNECT message to HNB-2 820 indicating a cause of “U-RNTI Collision”. Based on the cause in step 16, HNB-2 820 allocates (in step 17) a New U-RNTI value of the UE-2 815.

HNB-2 820 sends (in step 18) the New U-RNTI value to UE-2 815 in the UTRAN MOBILITY INFO message. In some embodiments, the UTRAN MOBILITY INFO message is an RRC UTRAN MOBILITY INFO message. UE-2 815 stores the new U-RNTI value and sends (in step 19) a confirmation message to HNB-2 820. In some embodiments, the confirmation message is a UTRAN MOBILITY INFO CONFIRM message. In some embodiments, the confirmation message is an RRC UTRAN MOBILITY INFO CONFIRM message. HNB-2 820 resends (in step 20) RUA CONNECT message to the HNB-GW 825 and includes the allocated New U-RNTI value and the CM Service Request message received from the UE-2 815. In some embodiments, the RUA CONNECT message also includes the associated UE context ID. The HNB-GW 825 stores (in step 21) the New U-RNTI value with the associated UE context ID and the call continues per normal.

B. Handover

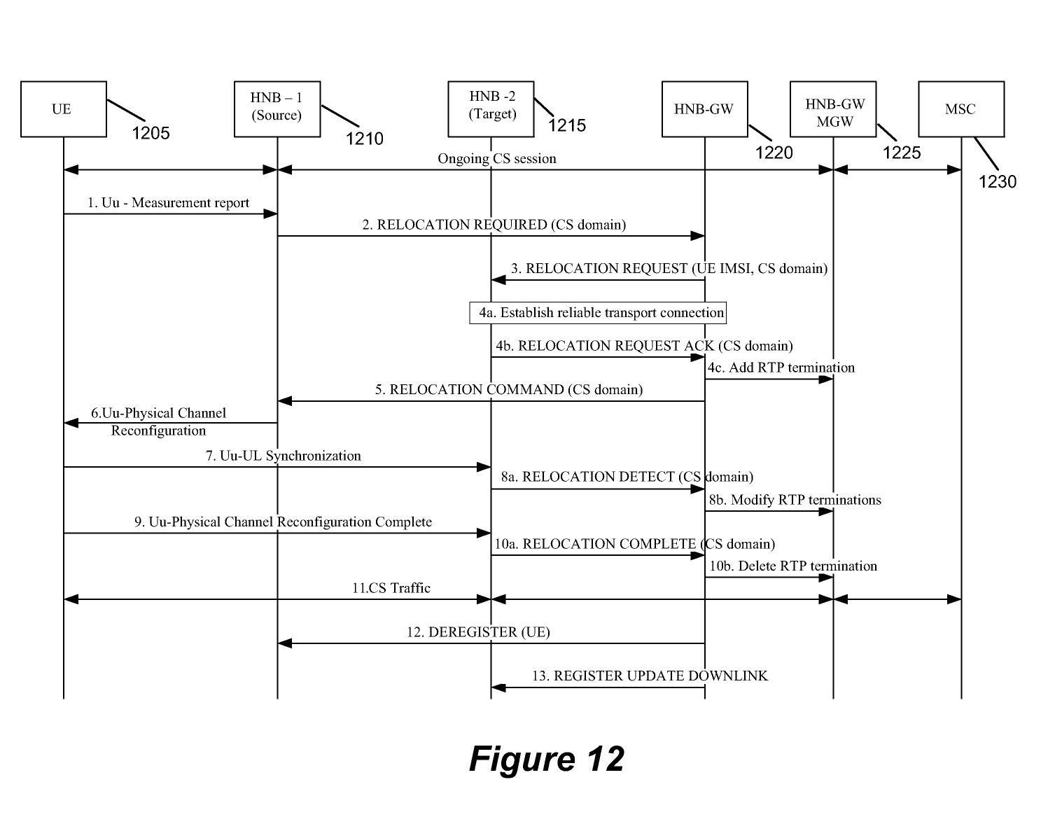

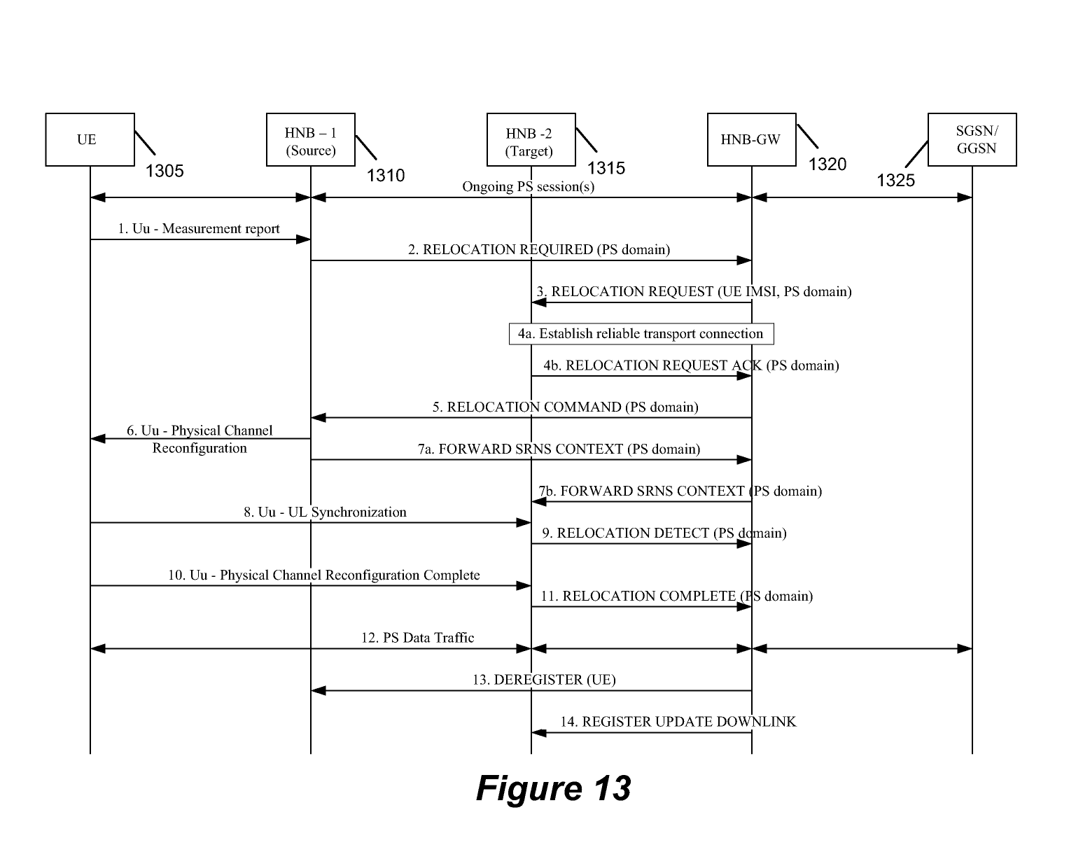

The following diagrams shown below can be implemented with different protocols. Some embodiments use the GA-CSR and GA-PSR protocols while other embodiments use RUA to encapsulate RANAP messages. Also, some embodiments use GA-RC protocol (e.g., for UE registration or discovery) while other embodiments use HNBAP protocol. For instance, the RELOCATION REQUIRED message (in step 2) of FIG. 12, below, can be a GA-CSR RELOCATION REQUIRED message in some embodiments. In some embodiments, the RELOCATION REQUIRED message (in step 2 of FIG. 12) can be a RANAP RELOCATION REQUIRED message. Similarly, in some embodiments, the RELOCATION REQUIRED message (in step 2) of FIG. 13 can be a GA-PSR RELOCATION REQUIRED message. In some embodiments, the RELOCATION REQUIRED message (in step 2 of FIG. 13) can be a RANAP RELOCATION REQUIRED message. As another example, in some embodiments, the DEREGISTER message (in step 12 of FIG. 12 or step 13 of FIG. 13) can be a GA-RC DEREGISTER message. In some embodiments, the DEREGISTER message can be a HNBAP DEREGISTER message.

1. Handout—CS Handover from HNB to UTRAN

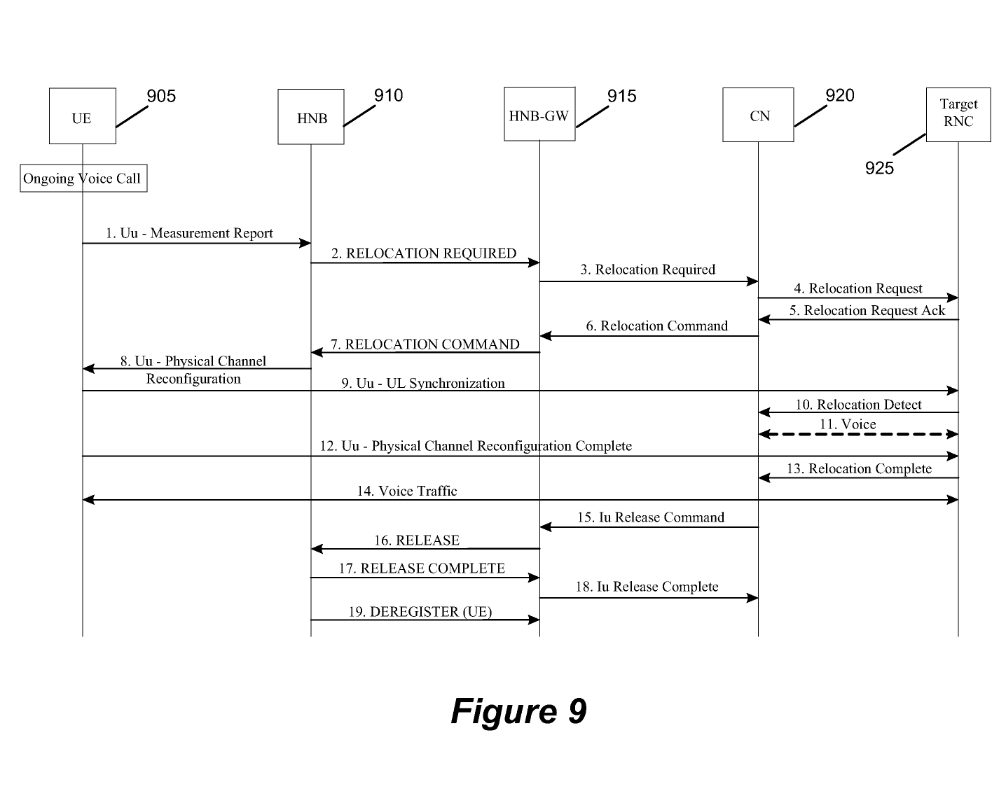

FIG. 9 illustrates circuit switched (CS) handover from HNB to UTRAN of some embodiments. The description of the procedures in this subsection assumes the following: (1) the UE is on an active call on the HNB, (2) the HNB is able to, either derive the neighbor list configuration (using a scan of its neighbor cells) or the HNB is configured with the neighbor information. The HNB must be able to distinguish other neighboring HNBs from the macro cells, and (3) the UE has been ordered (by the HNB) to make measurements on neighboring macro UTRAN cells.

As shown, the UE 905 sends (in step 1) periodic Measurement Report (Signal Measurement) to the camped HNB 910. The handover is triggered as a result of the UE 905 Measurement Reports indicating better signal strength on neighboring macro cell. The HNB 910 makes a decision on handover (e.g., based on the Measurement Reports from the UE 905 or any uplink quality indications received from the HNB-GW 915) and selects a target UTRAN cell. The HNB 910 then sends (in step 2) RELOCATION REQUIRED message to the HNB-GW 915. This message carries the information required by the HNB-GW 915 to construct the RANAP Relocation Required message, including the target RNC-ID.

Next, the HNB-GW 915 starts the handover preparation by signaling (in step 3) to the CN 920 the need for handover, using Relocation Required and including the target RNC-ID in the Target ID IE. The CN 920 starts the handover procedure towards the target RNC 925 identified by the Target ID IE in the Relocation Required message from the HNB-GW 915. The CN 920 requests (in step 4) the target RNC 925 to allocate the necessary resources using Relocation Request. The target RNC 925 builds a Physical Channel Reconfiguration message providing information on the allocated UTRAN resources and sends (in step 5) it to the CN 920 through the Relocation Request Acknowledge message.

The CN 920 signals (in step 6) the Serving HNB-GW 915 to handover the UE 905 to the UTRAN, using Relocation Command message (which includes the Physical Channel Reconfiguration message), ending the handover preparation phase. The Serving HNB-GW 915 transmits (in step 7) the RELOCATION COMMAND to the HNB 910 including the details sent by the UTRAN on the target resource allocation. The HNB 910 extracts the Physical Channel Reconfiguration message and sends (in step 8) it to the UE 905 over the Uu interface

Next, the UE 905 performs (in step 9) a handover into the new cell via uplink synchronization to the target RNS on the Uu interface. The target RNC 925 confirms (in step 10) the detection of the handover to the CN, using the Relocation Detect message. The CN 925 at this point switches (in step 11) the user plane to the target RNS. Upon completion of synchronization with the target RNS, the UE 905 signals (in step 12) completion of handover using the Physical Channel Reconfiguration Complete message.

The target RNC 925 confirms (in step 13) handover completion by sending the Relocation Complete message to the CN 920. Bi-directional voice traffic is now flowing (in step 14) between the UE 905 and CN 920, via the UTRAN. On receiving the confirmation of the completion of the handover, the CN 920 indicates (in step 15) to the Serving HNB-GW 915 to release any resources allocated to the UE, via the Iu Release Command.

Next, the Serving HNB-GW 915 commands (in step 16) the HNB 910 to release resources for the specific UE 905, using the RELEASE message. The HNB 910 confirms (in step 17) UE specific resource release using the RELEASE COMPLETE message to the HNB-GW 915. The Serving HNB-GW 915 confirms (in step 18) resource release to CN 920 using the Iu Release Complete message. The HNB 910 deregisters (in step 19) the UE 905 from the Serving HNB-GW 915, using an explicit DEREGISTER message.

2. Handout—CS Handover from HNB to GERAN

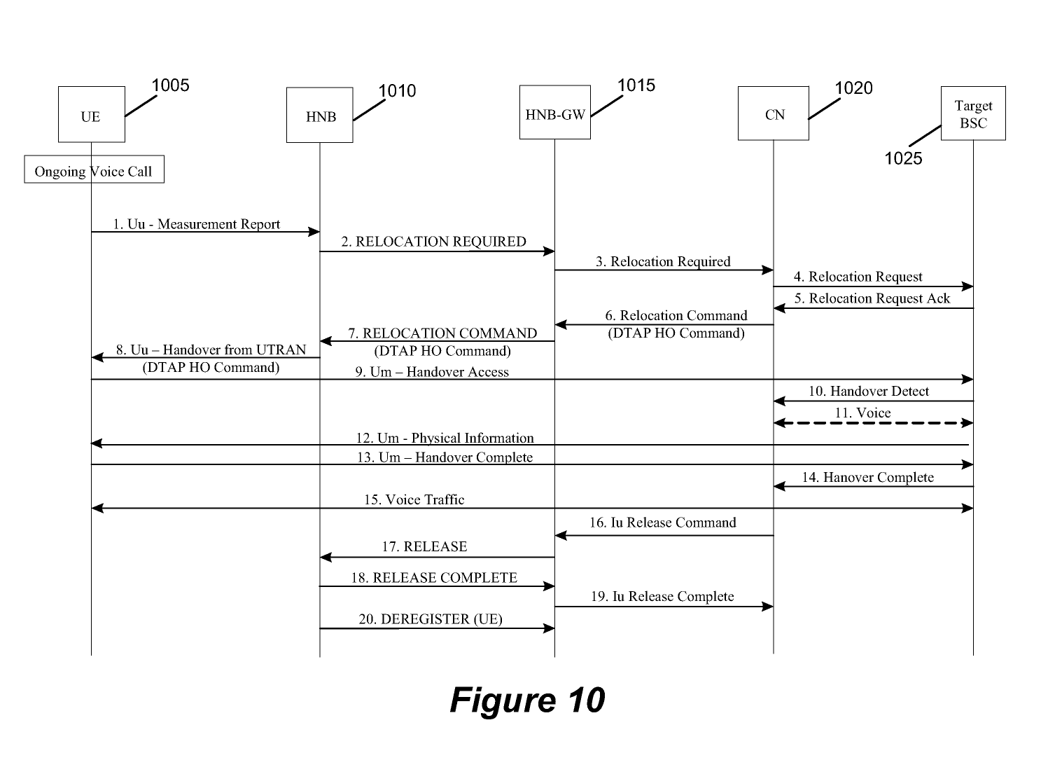

FIG. 10 illustrates CS handover from HNB to GERAN of some embodiments. The description of the procedures in this subsection assumes the following: (1) the UE is on an active call on the HNB, (2) the HNB is able to, either derive the neighbor list configuration (using a scan of its neighbor cells) or the HNB is configured with the neighbor information, and (3) the UE has been ordered (by the HNB) to make inter RAT measurements on neighboring GSM cells.

As shown, the UE 1005 sends (in step 1) periodic Measurement Report (Signal Measurement) to the camped HNB 1010. The handover is triggered as a result of the UE 1005 Measurement Reports indicating better signal strength on neighboring macro GSM cell. The HNB 1010 makes a decision on handover (e.g., based on the Measurement Reports from the UE 1005) and selects a target GSM cell. The HNB 1010 then sends (in step 2) RELOCATION REQUIRED message to the HNB-GW 1015. This message carries the information required by the HNB-GW 1015 to construct the RANAP Relocation Required message, including the target GERAN CGI.

Next, the HNB-GW 1015 starts the handover preparation by signaling (in step 3) to the CN 1020 the need for handover, using Relocation Required and including the target GERAN CGI in the Target ID IE. The CN 1020 starts (in step 4) the handover procedure towards the target GERAN identified by the Target ID IE (i.e., the GERAN CGI) in the Relocation Required message from the HNB-GW. The CN 1020 requests the target BSC 1025 to allocate the necessary resources using Handover Request. The target GERAN builds a Handover Command message providing information on the channel allocated and sends (in step 5) it to the CN 1020 through the Handover Request Acknowledge message.

The CN 1020 signals (in step 6) the Serving HNB-GW 1015 to handover the UE 1005 to the target GERAN, using Relocation Command message (which includes the DTAP Handover Command message), ending the handover preparation phase. The Serving HNB-GW 1015 transmits (in step 7) the RELOCATION COMMAND to the HNB 1010 including the details sent by the BSC on the target resource allocation. The HNB 1010 extracts the DTAP Handover Command message and sends (in step 8) it to the UE 1005 using the Uu: Handover from UTRAN message.

Next, the UE 1005 transmits (in step 9) the Um: Handover Access containing the handover reference element to allow the target GERAN to correlate this handover access with the Handover Command message transmitted earlier to the CN 1020 in response to the Handover Request. The target GERAN confirms (in step 10) the detection of the handover to the CN 1020, using the Handover Detect message. The CN 1020 at this point switches (in step 11) the user plane to the target BSS. The GERAN provides (in step 12) Physical Information to the UE 1005, i.e., Timing Advance, to allow the UE to synchronize with the GERAN.

The UE 1005 signals (in step 13) to the GERAN that the handover is completed, using Handover Complete. The GERAN confirms (in step 14) to the CN 1020 the completion of the handover, via Handover Complete message. The CN 1005 uses the target CGI used in the Handover procedure for charging purposes. Bi-directional voice traffic is now flowing (in step 15) between the UE 1005 and CN 1020, via the GERAN. On receiving the confirmation of the completion of the handover, the CN 1020 indicates (in step 16) to the Serving HNB-GW 1015 to release any resources allocated to the UE 1005, via the Iu Release Command.

Next, the Serving HNB-GW 1015 commands (in step 17) the HNB 1010 to release resources for the specific UE 1005, using the RELEASE message. The HNB 1010 confirms (in step 18) UE specific resource release using the RELEASE message to the HNB-GW 1015. The Serving HNB-GW 1015 confirms (in step 19) resource release to CN 1020 using the Iu Release Complete message. The HNB 1010 deregisters (in step 20) the UE 1005 from the Serving HNB-GW 1015, using an explicit DEREGISTER message.

3. Handout—PS Handover from HNB to UTRAN

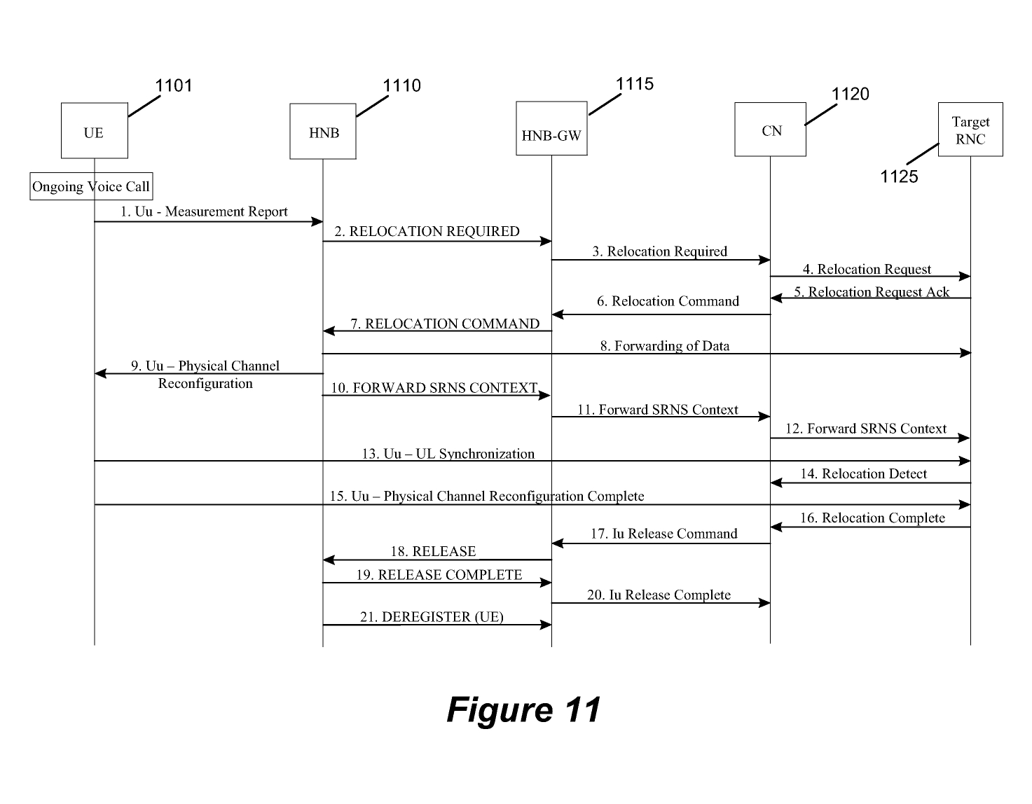

FIG. 11 illustrates PS handover from HNB to UTRAN of some embodiments. The description of the procedures in this subsection assumes the following: (1) the UE has an active PS session on the HNB, (2) the HNB is able to, either derive the neighbor list configuration (using a scan of its neighbor cells) or the HNB is configured with the neighbor information, and (3) the UE has been ordered (by the HNB) to make measurements on neighbouring macro UTRAN cells.

As shown, the UE 1105 sends (in step 1) periodic Measurement Report (Signal Measurement) to the camped HNB 1110. The handover is triggered as a result of the UE 1105 Measurement Reports indicating better signal strength on neighboring macro cell. The HNB 1110 makes a decision on handover based on the Measurement Report and selects a target UTRAN cell. The HNB 1110 then sends (in step 2) RELOCATION REQUIRED message to the HNB-GW 1115. This message carries the information required by the HNB-GW 1115 to construct the RANAP Relocation Required message, including the target RNC-ID.

Next, the HNB-GW 1115 starts the handover preparation by signaling (in step 3) to the CN 1120 the need for handover, using Relocation Required and including the target RNC-ID in the Target ID IE. The CN 1120 starts the handover procedure towards the target RNC 1125 identified by the Target ID IE in the Relocation Required message from the HNB-GW 1115. The CN 1120 requests (in step 4) the target RNC 1125 to allocate the necessary resources using Relocation Request. The target RNC 1125 builds a Physical Channel Reconfiguration message providing information on the allocated UTRAN resources and sends (in step 5) it to the CN 1120 through the Relocation Request Acknowledge message.

The CN 1120 signals (in step 6) the Serving HNB-GW 1115 to handover the UE 1105 to the UTRAN, using Relocation Command message (which includes the Physical Channel Reconfiguration message), ending the handover preparation phase. The Serving HNB-GW 1115 transmits (in step 7) the RELOCATION COMMAND to the HNB 1110 including the details sent by the UTRAN on the target resource allocation. The HNB 1110 begins forwarding of the data for the Radio Access Bearers (RABs) which are subject to data forwarding. For each radio bearer which uses lossless PDCP the GTP-PDUs related to transmitted but not yet acknowledged PDCP-PDUs are duplicated and routed at IP layer towards the target RNC 1125 together with their related downlink PDCP sequence numbers. The HNB 1110 continues transmitting duplicates of downlink data and receiving uplink data.

The order of steps from Step 8 onwards doesn't necessarily indicate the order of events. For example, steps 8 to 10 are performed by the HNB 1110 almost simultaneously. The HNB 1110 extracts the Physical Channel Reconfiguration message and sends (in step 9) it to the UE 1105 over the Uu interface. The HNB 1110 sends (in step 10) a FORWARD SRNS CONTEXT message to the HNB-GW 1115 to transfer the SRNS contexts to the target RNC via HNB-GW. The HNB-GW 1115 sends (in step 11) the corresponding Forward SRNS Context message to the associated CN 1120 node. The CN 1120 relays the SRNS Context information to the target RNC 1125.

The UE 1105 performs (in step 13) a handover into the new cell via uplink synchronization to the target RNS on the Uu interface. The target RNC 1125 confirms (in step 14) the detection of the handover to the CN, using the Relocation Detect message. Upon completion of synchronization with the target RNS, the UE 1105 signals (in step 15) completion of handover using the Physical Channel Reconfiguration Complete message. The target RNC 1125 confirms (in step 16) handover completion by sending the Relocation Complete message to the CN 1120.

Next, on receiving the confirmation of the completion of the handover, the CN 1120 indicates (in step 17) to the Serving HNB-GW 1115) to release any resources allocated to the UE, via the Iu Release Command. At this point, the CN 1120 also switches the PS user plane from HNB-GW 1115 to the target RNS. The Serving HNB-GW 1115 commands (in step 18) the HNB 1110 to release resources for the specific UE 1105, using the RELEASE message. The HNB 1105 confirms (in step 19) UE specific resource release using the RELEASE COMPLETE message to the HNB-GW 1115. The Serving HNB-GW 1115 confirms (in step 20) resource release to CN 1120 using the Iu Release Complete message. The HNB 1110 deregisters (in step 21) the UE 1105 from the Serving HNB-GW 1115, using an explicit DEREGISTER message.

4. Inter-HNB CS Handover

FIG. 12 illustrates inter-HNB CS handover of some embodiments. The description of the procedures in this figure assumes the following: (1) the UE is on an active CS call on HNB-1, (2) HNB-1 is configured with the neighbor information for other HNBs in the HNB Group, (3) and the UE has been ordered by HNB-1 to make measurements on the neighboring HNB cells in the HNB Group.

As shown, the UE 1205 sends (in step 1) periodic Measurement Report (Signal Measurement) to HNB-1 1210. The handover is triggered as a result of the UE 1205 Measurement Reports indicating better signal quality on a neighboring HNB in the HNB Group (HNB-2 1215). HNB-1 1210 makes a decision on handover to HNB-2 1215 (e.g., based on the Measurement Reports from the UE 1205 or any uplink quality indications received from the HNB-GW 1220). HNB-1 1210 sends (in step 2) the RELOCATION REQUIRED message to the HNB-GW 1220. This message includes the target RNC-ID and target Cell ID.

Next, the HNB-GW 1220 determines that this is an inter-HNB handover request since the target RNC-ID is the RNC-ID of the HNB-GW 1220. The HNB-GW 1220 then verifies that there is another HNB registered that is in the same group as HNB-1 1210 and has the same 3G Cell ID as that provided by HNB-1 1210 in the target Cell ID. The HNB-GW 1220 sends (in step 3) the RELOCATION REQUEST message to the target HNB (HNB-2 1215) using the HNB 1215's signaling channel.

If a reliable transport connection has not been established between HNB-2 1215 and HNB-GW 1220, HNB-2 1215 establishes (in step 4a) a reliable transport connection to the HNB-GW 1220. If a reliable transport connection has been established between HNB-2 1215 and HNB-GW 1220, the connection establishment step (step 4a) is omitted. In some embodiments, the reliable transport connection is a SCTP connection. In some embodiments, the reliable transport connection is a TCP connection. In some embodiments, the reliable transport connection is shared by all UEs while in other embodiments the connection is for UE-specific signaling purposes. HNB-2 1215 builds a Physical Channel Reconfiguration message providing information on the allocated UTRAN resources and sends (in step 4b) it to the HNB-GW 1220 in the RELOCATION REQUEST ACK message using the established UE signaling channel, if established. All subsequent UE-specific signaling between HNB-2 1215 and the HNB-GW 1220 use the UE 1205's signaling channel. The UE signaling channel is used only if a UE specific transport connection is established in the preceding steps. HNB-2 1215 also includes the allocated RTP endpoint information to be used for the CS bearer channel. The HNB-GW 1220 adds (in step 4c) an RTP termination from the HNB-GW media gateway function (HNB-GW MGW) 1225 to HNB-2 1215 enabling uni-directional traffic flow from the CN 1230 to HNB-2 1215 in addition to the bi-directional traffic flow between the CN 1230 and HNB-1 1210.

Next, the HNB-GW 1220 transmits (in step 5) the RELOCATION COMMAND to HNB-1 1210 including the details sent by HNB-2 1215 on the target resource allocation. HNB-1 1210 extracts the Physical Channel Reconfiguration message and sends (in step 6) it to the UE 1205 over the Uu interface. The UE 1205 performs (in step 7) a handover into the new cell via uplink synchronization to HNB-2 1215 on the Uu interface.

On detection of the UE 1205 access, HNB-2 1215 confirms (in step 8a) the detection of the handover to the HNB-GW 1220, using the RELOCATION DETECT message, sent via the UE 1205's signaling channel. On receipt of the message, the HNB-GW 1220 modifies (in step 8b) the HNB-GW MGW 1225 RTP terminations to enable bi-directional CS traffic flow between the CN 1230 and HNB-2 1215 and uni-directional traffic flow from the CN 1230 to HNB-1 1210.

Next, upon completion of synchronization with HNB-2 1215, the UE 1205 signals (in step 9) completion of handover using the Physical Channel Reconfiguration Complete message. HNB-2 1215 confirms handover completion by sending (in step 10a) the RELOCATION COMPLETE message to the HNB-GW 1220. On receipt of the message, the HNB-GW 1220 deletes (in step 10b) the HNB-GW MGW 1225 RTP termination to HNB-1 1210.

Bi-directional CS traffic is now flowing (in step 11) between the UE 1205 and CN 1230, via HNB-2 1215 and the HNB-GW MGW 1225. The HNB-GW 1220 deregisters the UE 1205 on HNB-1 1210 by sending (in step 12) the DEREGISTER message with reject cause value ‘Inter-HNB handover complete’. HNB-1 releases the resources assigned to the UE 1205 and deletes all stored context information associated with the UE 1205. The HNB-GW 1220 sends (in step 13) a REGISTER UPDATE DOWNLINK message to HNB-2 1215 on the UE 1205's signaling channel, providing any UE-specific service parameters. This step occurs any time after the HNB-GW 1220 receives the RELOCATION DETECT message.

The above messages disclosed in FIG. 12 can be implemented using various different types of protocols. In some embodiments, some of the above messages are implemented using GA-CSR protocol. For instance, the message in step 2 is a GA-CSR RELOCATION REQUIRED, the message in step 3 is GA-CSR RELOCATION REQUEST (UE IMSI), the message in step 4b is GA-CSR RELOCATION REQUEST ACK, the message in step 5 is GA-CSR RELOCATION COMMAND, the message in step 8a is GA-CSR RELOCATION DETECT, and the message in step 10a is GA-CSR RELOCATION COMPLETE.

In other embodiments, these messages are implemented using RANAP messages encapsulated in RUA. For instance, the message in step 2 is a RUA DIRECT TRANSFER (RANAP Relocation Required (CS domain)) message, the message in step 3 is RUA DIRECT TRANSFER (RANAP Relocation Request (UE IMSI, CS domain)), the message in step 4b is RUA DIRECT TRANSFER (RANAP Relocation Request Ack (CS domain)), the message in step 5 is RUA DIRECT TRANSFER(RANAP Relocation Command (CS domain)), the message in step 8a is RUA DIRECT TRANSFER(RANAP Relocation Detect (CS domain), and the message in step 10a is RUA DIRECT TRANSFER (RANAP Relocation Complete (CS domain)). In some embodiments, the RUA encapsulating message can be an RUA message other than the RUA DIRECT TRANSFER message. Similarly other lightweight protocols can be used in some embodiments to wrap the RANAP messages.

In some embodiments, some of the above messages are implemented using GA-RC messages. For instance, the message in step 12 is GA-RC DEREGISTER (UE) and the message in step 13 is GA-RC REGISTER UPDATE DOWNLINK. In other embodiments, some of the above messages are implemented using HNBAP protocol. For instance, the message in step 12 is HNBAP DEREGISTER (UE) and the message in step 13 is HNBAP REGISTER UPDATE DOWNLINK (UE).

5. Inter-HNB PS Handover

FIG. 13 illustrates inter-HNB PS handover of some embodiments. The description of the procedures in this subsection assumes the following: (1) the UE has one or more active PS sessions on HNB-1, (2) HNB-1 is configured with the neighbor information for other HNBs in the HNB Group, and (3) the UE has been ordered by HNB-1 to make measurements on the neighboring HNB cells in the HNB Group.

As shown, the UE 1305 sends (in step 1) periodic Measurement Report (Signal Measurement) to HNB-1 1310. The handover is triggered as a result of the UE 1305 Measurement Reports indicating better signal strength on a neighboring HNB in the HNB Group (HNB-2 1315). HNB-1 1310 makes a decision on handover (e.g., based on the Measurement Reports from the UE 1305 or any uplink quality indications received from the HNB-GW 1320) to HNB-2 1315. HNB-1 1310 sends (in step 2) RELOCATION REQUIRED message to the HNB-GW 1320. This message includes the target RNC-ID and target Cell ID.

Next, the HNB-GW 1320 determines that this is an inter-HNB handover request since the target RNC-ID is the RNC-ID of the HNB-GW 1320. The HNB-GW 1320 then verifies that there is another registered HNB that is in the same group as HNB-1 1310 and has the same 3G Cell ID as that provided by HNB-1 1310 in the target Cell ID. The HNB-GW 1320 sends (in step 3) the RELOCATION REQUEST message to the target HNB (HNB-2 1315) using the HNB 1315's signaling channel. The HNB-GW 1320 includes the allocated core network GTP-U tunnel endpoint IP address(es) and TEID(s) to be used for the PS transport channel(s).

If a reliable transport connection has not been established between HNB-2 1315 and HNB-GW 1320, HNB-2 1315 establishes (in step 4a) a reliable transport connection to the HNB-GW 1320. If a reliable transport connection has been established between HNB-2 1315 and HNB-GW 1320, the connection establishment step (step 4a) is omitted. In some embodiments, the reliable transport connection is a SCTP connection. In some embodiments, the reliable transport connection is a TCP connection. In some embodiments, the reliable transport connection is shared by all UEs while in other embodiments the connection is for UE-specific signaling purposes. HNB-2 1315 builds a Physical Channel Reconfiguration message providing information on the allocated UTRAN resources and sends (in step 4b) it to the HNB-GW 1320 in the RELOCATION REQUEST ACK message using the newly established UE signaling channel, if established. The RELOCATION REQUEST ACK message contains the UE IMSI to allow the HNB-GW 1320 to associate the new signaling channel with the UE 1305. All subsequent UE-specific signaling between HNB-2 1315 and the HNB-GW 1320 uses the UE 1305's signaling channel. The UE signaling channel is used only if a UE specific transport connection is established in preceding steps. HNB-2 1315 also includes its GTP-U tunnel endpoint IP address and a locally-allocated TEID(s) to be used for the PS transport channel(s).

The GTP-U Relay function detects the RELOCATION REQUEST ACK message on the new UE signaling channel to obtain (a) the UE IMSI, and (b) the GTP-U tunnel endpoint IP address and TEID(s) allocated by HNB-2 1315. It will then be prepared to switch the GTP-U path on receipt of RELOCATION DETECT on the new signaling channel (step 9).

The HNB-GW 1320 transmits (in step 5) the RELOCATION COMMAND to HNB-1 1310 including the details on the target resource allocation. In some embodiments, the HNB-GW 1320 does not include the “RABs Subject To Data Forwarding List” IE. Therefore, the HNB-1 1310 does not perform data forwarding for any RABs during PS handover. In some embodiments, the following steps 6 and 7 are performed by the HNB-1 1310 substantially simultaneously.

Next, HNB-1 1310 extracts the Physical Channel Reconfiguration message and sends (in step 6) it to the UE 1305 over the Uu interface. HNB-1 1310 sends (in step 7a) a FORWARD SRNS CONTEXT message to the HNB-GW 1320 to transfer the SRNS contexts to the target HNB 1315 via HNB-GW 1320. The HNB-GW 1320 relays (in step 7b) the FORWARD SRNS CONTEXT message to HNB-2 1315. The UE 1305 performs (in step 8) a handover into the new cell via uplink synchronization to HNB-2 1315 on the Uu interface.

On detection of the UE 1305 access, HNB-2 1315 confirms (in step 9) the detection of the handover to the HNB-GW, using the RELOCATION DETECT message, sent via the UE 1305's signaling channel. At this point, the GTP-U Relay function in the HNB-GW 1320 switches the PS transport channel path, relaying downlink packets associated with the GTP-U tunnel(s) to the HNB-2 1315 IP address and TEID(s) detected in the RELOCATION REQUEST ACK message monitored in step 4 and relaying uplink packets from HNB-2 1315 to the core network 1325. Upon completion of synchronization with HNB-2 1315, the UE 1305 signals (in step 10) completion of handover using the Physical Channel Reconfiguration Complete message. HNB-2 1315 confirms handover completion by sending the RELOCATION COMPLETE message to the HNB-GW 1320.

Bi-directional PS traffic is now flowing (in step 12) between the UE 1305 and CN 1325, via HNB-2 1315 and the HNB-GW GTP-U Relay function. The HNB-GW 1320 deregisters the UE 1305 on HNB-1 1310 by sending (in step 13) the DEREGISTER message with reject cause value ‘Inter-HNB handover complete’. HNB-1 1310 releases the resources assigned to the UE 1305 and deletes all stored context information associated with the UE 1305. The HNB-GW 1320 sends (in step 14) a REGISTER UPDATE DOWNLINK message to HNB-2 1315 on the UE 1305's signaling channel, providing any UE-specific service parameters. This step occurs any time after the HNB-GW 1320 receives the RELOCATION DETECT message.

The above messages disclosed in FIG. 13 can be implemented using various different types of protocols. In some embodiments, some of the above messages are implemented using GA-PSR protocol. For instance, the message in step 2 is a GA-PSR RELOCATION REQUIRED, the message in step 3 is GA-PSR RELOCATION REQUEST (UE IMSI), the message in step 4b is GA-PSR RELOCATION REQUEST ACK, the message in step 5 is GA-PSR RELOCATION COMMAND, the message in step 9 is GA-PSR RELOCATION DETECT, and the message in step 11 is GA-PSR RELOCATION COMPLETE.

In other embodiments, these messages are implemented using RANAP messages encapsulated in RUA. For instance, the message in step 2 is a RUA DIRECT TRANSFER (RANAP Relocation Required (PS domain)) message, the message in step 3 is RUA DIRECT TRANSFER (RANAP Relocation Request (UE IMSI, PS domain)), the message in step 4b is RUA DIRECT TRANSFER (RANAP Relocation Request Ack (PS domain)), the message in step 5 is RUA DIRECT TRANSFER(RANAP Relocation Command (PS domain)), the message in step 9 is RUA DIRECT TRANSFER(RANAP Relocation Detect (PS domain), and the message in step 11 is RUA DIRECT TRANSFER (RANAP Relocation Complete (PS domain)). In some embodiments, the RUA encapsulating message can be an RUA message other than the RUA DIRECT TRANSFER message. Similarly other lightweight protocols can be used in some embodiments to wrap the RANAP messages.

In some embodiments, some of the above messages are implemented using GA-RC messages. For instance, the message in step 13 is GA-RC DEREGISTER (UE) and the message in step 14 is GA-RC REGISTER UPDATE DOWNLINK. In other embodiments, some of the above messages are implemented using HNBAP protocol. For instance, the message in step 13 is HNBAP DEREGISTER (UE) and the message in step 14 is HNBAP REGISTER UPDATE DOWNLINK (UE).

6. Inter-HNB CS & PS Handover

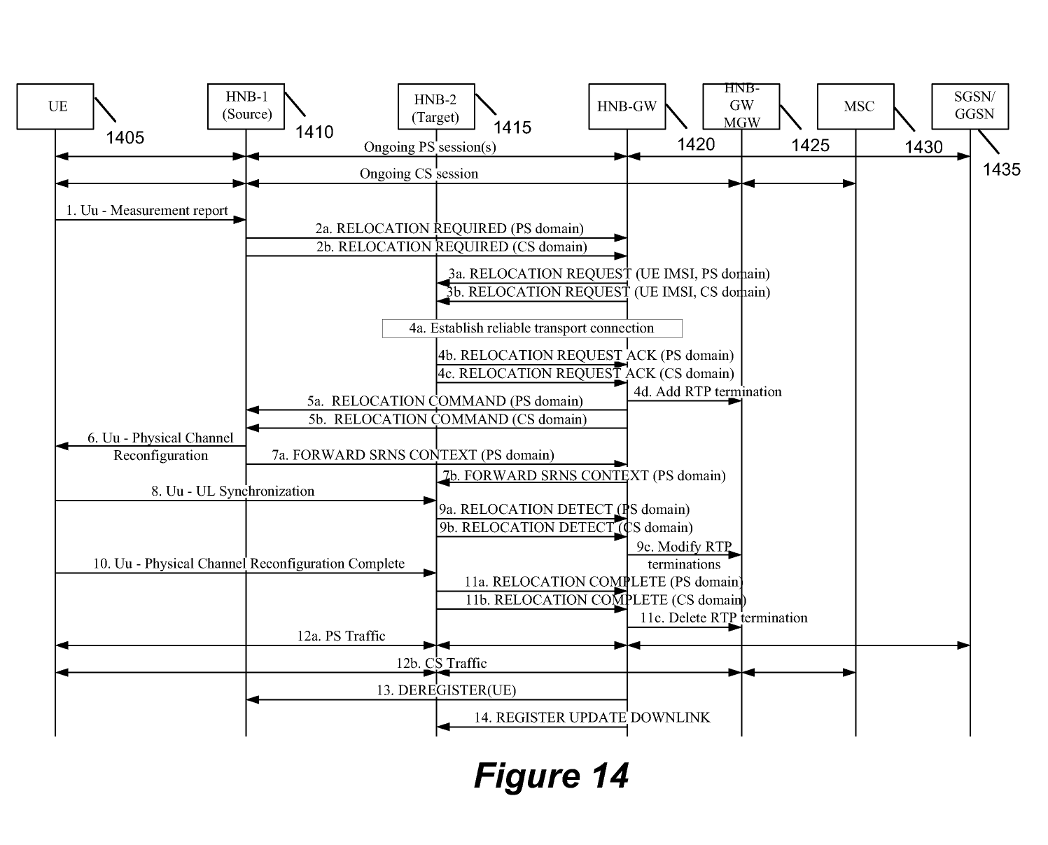

FIG. 14 illustrates inter-HNB CS+PS handover of some embodiments. This scenario is realized with the combination of the scenarios illustrated in the “Inter-HNB CS handover” and the “Inter-HNB PS handover” subsections, above. The description of the procedures in this subsection assumes the following: (1) the UE has active PS and CS sessions on HNB-1, (2) HNB-1 is configured with the neighbor information for other HNBs in the HNB Group, (3) the UE has been ordered by HNB-1 to make measurements on the neighboring HNB cells in the HNB Group, and (4) the HNBs are responsible for the coordination of the CS and PS relocations.

As shown, some embodiments send two of the same message with one message indicating one domain (e.g., RELOCATION REQUIRED (PS domain)) and the other message indicating a different domain (e.g., RELOCATION REQUIRED (CS domain)). For example, steps 2a and 2b, each sends a RELOCATION REQUIRED message. Step 2a sends the RELOCATION REQUIRED message indicating a PS domain while step 2b sends the RELOCATION REQUIRED message indicating a CS domain. In some embodiments, one message is sent indicating both domains instead of two separate messages each indicating different domains. For instance, a RELOCATION REQUIRED message indicating the PS domain and CS domain (e.g., RELOCATION REQUIRED (PS domain, CS domain) is sent in step 2 instead of the two messages sent in steps 2a and 2b. Similarly steps 3a and 3b, steps 4b and 4c, steps 5a and 5b, steps 9a and 9b, and steps 11a and 11b can be implemented by sending only one message indicating both CS and PS domains.

As shown, the UE 1405 sends (in step 1) periodic Measurement Report (Signal Measurement) to HNB-1 1410. The handover is triggered as a result of the UE 1405 Measurement Reports indicating better signal strength on a neighboring HNB in the HNB Group (HNB-2 1415). HNB-1 1410 makes a decision on handover (e.g., based on the Measurement Reports from the UE 1405 or any uplink quality indications received from the HNB-GW) to HNB-2 1415. HNB-1 1410 sends (in steps 2a and 2b) RELOCATION REQUIRED and RELOCATION REQUIRED messages to the HNB-GW 1420. These messages carry the target RNC-ID and target Cell ID. HNB-1 1410 would request that both CS and PS domains be relocated by including the Number of Domains Relocating IE (i.e., with value set to ‘2’) in both the RELOCATION REQUIRED and RELOCATION REQUIRED messages.

Next, the HNB-GW 1420 determines that this is an inter-HNB handover request since the target RNC-ID is the RNC-ID of the HNB-GW 1420. The HNB-GW 1420 then verifies that there is another registered HNB that is in the same group as HNB-1 1410 and has the same 3G Cell ID as that provided by HNB-1 1410 in the target Cell ID. The HNB-GW 1420 sends (in steps 3a and 3b) the RELOCATION REQUEST and RELOCATION REQUEST messages to the target HNB (HNB-2 1415) using the HNB 1415's signaling channel. In the RELOCATION REQUEST, the HNB-GW 1420 includes the allocated core network GTP-U tunnel endpoint IP address(es) and TEID(s) to be used for the PS transport channel(s).

If a reliable transport connection has not been established between HNB-2 1415 and HNB-GW 1420, HNB-2 1415 establishes (in step 4a) a reliable transport connection to the HNB-GW 1420 after receiving both the RELOCATION REQUEST and RELOCATION REQUEST messages. If a reliable transport connection has been established between HNB-2 1415 and HNB-GW 1420, the connection establishment step (step 4a) is omitted. In some embodiments, the reliable transport connection is SCTP connection. In some embodiments, the reliable transport connection is a TCP connection. In some embodiments, the reliable transport connection is shared by all UEs while in other embodiments the connection is for UE-specific signaling purposes. HNB-2 1415 builds a Physical Channel Reconfiguration message providing information on the allocated UTRAN resources and sends (in steps 4b and 4c) it to the HNB-GW 1420 in the RELOCATION REQUEST ACK and RELOCATION REQUEST ACK messages using the newly established UE signaling channel, if established. The RELOCATION REQUEST ACK and RELOCATION REQUEST ACK messages include the UE IMSI to allow the HNB-GW 1420 to associate the new signaling channel with the UE 1405). All subsequent UE-specific signaling between HNB-2 1415 and the HNB-GW 1420 uses the UE 1405's signaling channel. The UE signaling channel is used only if a UE specific transport connection is established in preceding steps. HNB-2 1415 includes the allocated RTP endpoint information to be used for the CS bearer channel in the RELOCATION REQUEST ACK message. HNB-2 1415 includes its GTP-U tunnel endpoint IP address and a locally-allocated TEID(s) to be used for the PS transport channel(s) in the RELOCATION REQUEST ACK message. The HNB-GW 1420 adds (in step 4d) an RTP termination from the HNB-GW MGW 1425 to HNB-2 1415 enabling uni-directional CS traffic flow from the CN to HNB-2 1415 in addition to the bi-directional traffic flow between the CN and HNB-1 1410.

The GTP-U Relay function detects the RELOCATION REQUEST ACK message on the new UE signaling channel to obtain (a) the UE IMSI, and (b) the GTP-U tunnel endpoint IP address(es) and TEID(s) allocated by HNB-2 1415. It is prepared to switch the GTP-U path on receipt of RELOCATION DETECT on the new signaling channel (step 9).

The HNB-GW 1420 transmits (in steps 5a and 5b) the RELOCATION COMMAND and RELOCATION COMMAND messages to HNB-1 1410 including the details on the target resource allocation. In some embodiments, the HNB-GW 1420 does not include the “RABs Subject To Data Forwarding List” IE in the RELOCATION COMMAND message. Therefore, the HNB-1 1410 does not perform data forwarding for any RABs during PS handover. In some embodiments, the following steps 6 and 7 are performed by the HNB almost simultaneously.

Next, HNB-1 1410 extracts the Physical Channel Reconfiguration message and sends (in step 6) it to the UE 1405 over the Uu interface. HNB-1 1410 sends (in step 7a) a FORWARD SRNS CONTEXT message to the HNB-GW 1420 to transfer the SRNS contexts to the target HNB 1415 via HNB-GW 1420. The HNB-GW 1420 relays (in step 7b) the FORWARD SRNS CONTEXT message to HNB-2 1415. The UE 1405 performs (in step 8) a handover into the new cell via uplink synchronization to HNB-2 1415 on the Uu interface.

On detection of the UE access, HNB-2 1415 confirms (in step 9) the detection of the handover to the HNB-GW 1420, using the RELOCATION DETECT and RELOCATION DETECT messages, sent via the UE 1405's signaling channel. On receipt of the RELOCATION DETECT message, the HNB-GW 1420 modifies the HNB-GW MGW 1425 RTP terminations to enable bi-directional CS traffic flow between the CN and HNB-2 1415 and uni-directional traffic flow from the CN to HNB-1 1410. At this point, the GTP-U Relay function in the HNB-GW 1420 switches the PS transport channel path, relaying downlink packets associated with the GTP-U tunnel to the HNB-2 1415 IP address and TEID detected in the RELOCATION REQUEST ACK message monitored in step 4 and relaying uplink packets from HNB-2 1415 to the core network. Upon completion of synchronization with HNB-2 1415, the UE 1405 signals (in step 10) completion of handover using the Physical Channel Reconfiguration Complete message. HNB-2 1415 confirms handover completion by sending (in steps 11a and 11b) the RELOCATION COMPLETE and RELOCATION COMPLETE messages to the HNB-GW 1420. On receipt of the RELOCATION COMPLETE message, the HNB-GW 1420 deletes (in step 11c) the HNB-GW MGW 1425 RTP termination to HNB-1 1410.

Bi-directional PS traffic is now flowing (in steps 12a) between the UE 1405 and CN 1435, via HNB-2 1415 and the HNB-GW 1420 GTP-U Relay function. Bi-directional CS traffic is now flowing (in step 12b) between the UE 1405 and CN 1430, via HNB-2 1415 and the HNB-GW MGW 1425. The HNB-GW 1420 deregisters the UE 1405 on HNB-1 1410 by sending (in step 13) the DEREGISTER message with reject cause value ‘Inter-HNB handover complete’. HNB-1 1410 releases the resources assigned to the UE 1405 and deletes all stored context information associated with the UE 1405. This step occurs any time after the HNB-GW 1420 receives one or both of the RELOCATION COMPLETE and RELOCATION COMPLETE messages. The HNB-GW 1420 sends (in step 14) a REGISTER UPDATE DOWNLINK message to HNB-2 1415 on the UE 1405's signaling channel, providing any UE-specific service parameters. This step occurs any time after the HNB-GW receives one or both of the RELOCATION DETECT and RELOCATION DETECT messages.

The above messages disclosed in FIG. 14 can be implemented using various different types of protocols. In some embodiments, some of the above messages are implemented using GA-CSR and GA-PSR protocols. For instance, the messages in steps 2a and 2b are a GA-PSR RELOCATION REQUIRED and GA-CSR RELOCATION REQUIRED respectively, the messages in steps 3a and 3b are GA-PSR RELOCATION REQUEST (UE IMSI) and GA-CSR RELOCATION REQUEST (UE IMSI) respectively, the messages in steps 4b and 4c are GA-PSR RELOCATION REQUEST ACK and GA-CSR RELOCATION REQUEST ACK respectively, the messages in steps 5a and 5b are GA-PSR RELOCATION COMMAND and GA-CSR RELOCATION COMMAND respectively, the messages in steps 9a and 9b are GA-CSR RELOCATION DETECT respectively, and the messages in steps 11a and 11b are GA-PSR RELOCATION COMPLETE and GA-CSR RELOCATION COMPLETE respectively.

In other embodiments, these messages are implemented using RANAP messages encapsulated in RUA. For instance, the messages in steps 2a and 2b are RUA DIRECT TRANSFER (RANAP Relocation Required (PS domain)) and RUA DIRECT TRANSFER (RANAP Relocation Required (CS domain)) respectively, the messages in steps 3a and 3b are RUA DIRECT TRANSFER (RANAP Relocation Request (UE IMSI, PS domain)) and RUA DIRECT TRANSFER (RANAP Relocation Request (UE IMSI, CS domain)) respectively, the messages in step 4b and 4c are RUA DIRECT TRANSFER (RANAP Relocation Request Ack (PS domain)) and RUA DIRECT TRANSFER (RANAP Relocation Request Ack (CS domain)) respectively, the messages in steps 5a and 5b are RUA DIRECT TRANSFER(RANAP Relocation Command (PS domain)) and RUA DIRECT TRANSFER(RANAP Relocation Command (CS domain)) respectively, the messages in steps 9a and 9b are RUA DIRECT TRANSFER(RANAP Relocation Detect (PS domain) and RUA DIRECT TRANSFER(RANAP Relocation Detect (CS domain) respectively, and the messages in step 11a and 11b are RUA DIRECT TRANSFER (RANAP Relocation Complete (PS domain)) and RUA DIRECT TRANSFER (RANAP Relocation Complete (CS domain)) respectively. In the embodiments that only one message is sent in the steps indicated in this paragraph, the RUA DIRECT TRANSFER message encapsulates a RANAP message that as both PS domain and CS domain indications.

In some embodiments, some of the above messages are implemented using GA-RC messages. For instance, the message in step 13 is GA-RC DEREGISTER (UE) and the message in step 14 is GA-RC REGISTER UPDATE DOWNLINK. In other embodiments, some of the above messages are implemented using HNBAP protocol. For instance, the message in step 13 is HNBAP DEREGISTER (UE) and the message in step 14 is HNBAP REGISTER UPDATE DOWNLINK (UE).

7. Cell Update in the CELL_FACH State

When the UE is in the Cell Forward Access Channel (CELL_FACH) state and then reselects to a HNB from a macro cell and initiates the cell update procedure on the HNB, the HNB responds with a RRC Connection Release message with cause “Directed signalling connection re-establishment”. According to “Mobile radio interface layer 3 specification; Core network protocols; Stage 3,” 3GPP TS 24.008, sub-clause 4.7.2.5, the UE enters PMM-IDLE mode and immediately initiates a normal routing area update procedure (the use of normal or combined procedure depends on the network operation mode in the current serving cell) regardless whether the routing area has been changed since the last update or not.

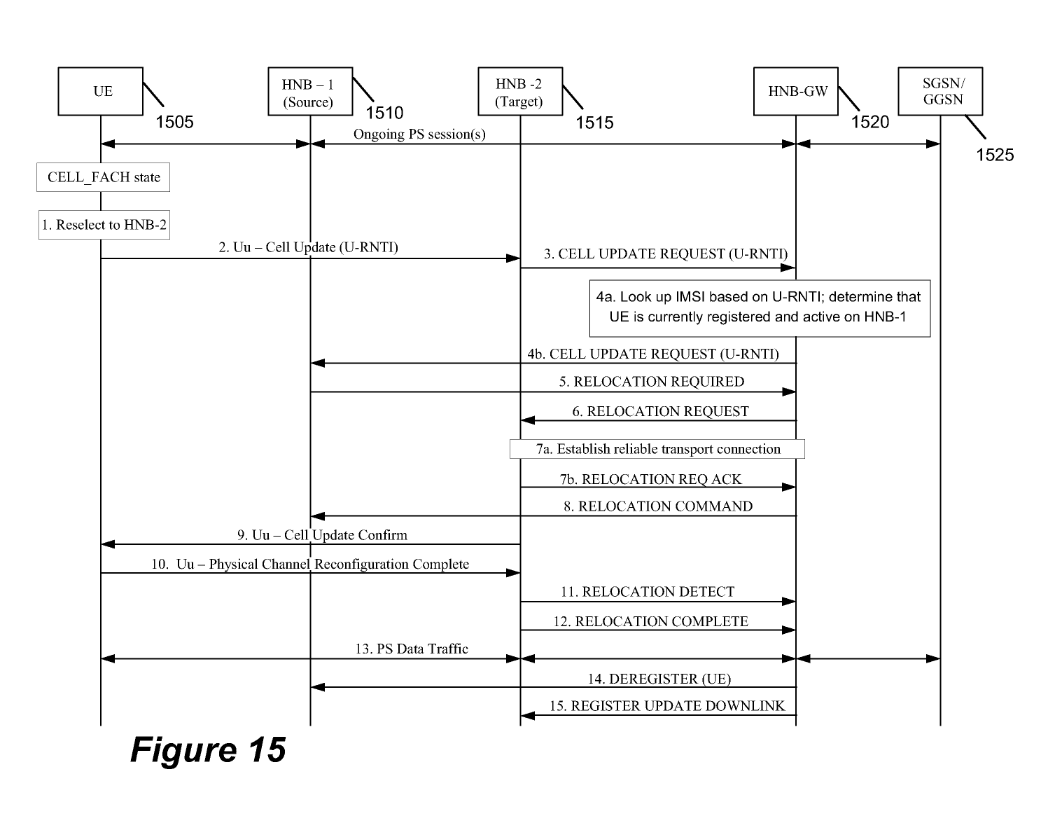

FIG. 15 illustrates cell update in the CELL_FACH state in some embodiments. When the UE is in the CELL_FACH state, the UE does not have a dedicated radio channel between the UE and a HNB as described in “Radio Resource Control (RRC) Protocol Specification,” 3GPP TS 25.331, clause 7. This can happen, for instance, when the UE has an ongoing PS session but there is no data transfer for a certain time. The HNB system will delete the radio channel because the UE has been idle for some time. However the UE has not been idle for such a long time that HNB system tears down the PS session. Therefore, the PS session is maintained but the UE goes into the CELL-FACH state where it is transmitting data occasionally, not frequently. When the UE is in the CELL_FACH state and then reselects to a HNB from another HNB in the same HNB group and initiates the cell update procedure on the HNB, the following procedure applies. The description of the procedures in this subsection assumes that the UE has one or more active PS session on HNB-1 but has moved to the CELL_FACH state.

As shown, the UE 1505 re-selects (in step 1) to HNB-2 1516 while in the CELL_FACH state. The UE 1505 sends (in step 2) a Cell Update message to HNB-2 1515 including the U-RNTI assigned to the UE 1505 by HNB-1 1510. HNB-2 1515 is a group HNB and determines that the RNC-ID portion of the U-RNTI corresponds to one of the RNC-IDs that is assigned to HNB-2 1515's serving HNB-GW 1520. HNB-2 1515 learns the RNC-ID(s) that is(are) assigned to the HNB-GW 1520 during the HNB registration process

Next, HNB-2 1515 sends (in step 3) a CELL UPDATE REQUEST message to the HNB-GW 1520 using the HNB-2 1515's signaling channel and including the U-RNTI and HNB-2 1515's Cell ID. The HNB-GW 1520 looks up (in step 4a) the UE1 1505's IMSI based on the U-RNTI value and determines that the UE 1505 is currently registered on HNB-1 1510 and has one or more active PS sessions as described in the “Management of U-RNTI” section, above. Therefore, the HNB-GW1520 relays (in step 4b) the CELL UPDATE REQUEST message to HNB-1 1510 via the UE 1505's signaling channel. The message includes the U-RNTI. If the HNB-GW1520 determines that there are no other registered HNBs in the HNB group, then the HNB-GW 1520 sends the CELL UPDATE REJECT message to HNB-2 1515. In this case, HNB-2 1515 (as described above) proceeds similar to the case of cell update from a macro cell (i.e., send the RRC Connection Release message with cause “Directed signaling connection re-establishment”).

The receipt of the CELL UPDATE REQUEST message triggers HNB-1 1510 to initiate PS handover to HNB-2 1515. HNB-1 1510 sends (in step 5) the RELOCATION REQUIRED message to the HNB-GW 1520. This message carries the target RNC-ID (corresponding to the HNB-GW) and target Cell ID (provided in step 4). The reason for relocation is ‘Cell Update’. The HNB-GW 1520 determines that this is an inter-HNB handover request for cell update purposes. The HNB-GW 1520 sends (in step 6) the RELOCATION REQUEST message to the target HNB (HNB-2 1515) using the HNB 1515's signaling channel. The HNB-GW 1520 includes the allocated core network GTP-U tunnel endpoint IP address and TEID(s) that are being used for the PS transport channel(s). The reason for relocation is ‘Cell Update’.

Next, if a reliable transport connection has not been established between HNB-2 1515 and HNB-GW 1520, HNB-2 1515 establishes (in step 7a) a reliable transport connection to the HNB-GW 1520. If a reliable transport connection has been established between HNB-2 1515 and HNB-GW 1520, the connection establishment step (step 7a) is omitted. In some embodiments, the reliable transport connection is a SCTP connection. In some embodiments, the reliable transport connection is a TCP connection. In some embodiments, the reliable transport connection is shared by all UEs while in other embodiments the connection is for UE-specific signaling purposes. HNB-2 1515 builds a Physical Channel Reconfiguration message providing information on the allocated UTRAN resources and sends (in step 7b) it to the HNB-GW 1520 in the RELOCATION REQUEST ACK message using the newly established UE signaling channel. The RELOCATION REQUEST ACK message contains the UE IMSI to allow the HNB-GW 1520 to associate the new signaling channel with the UE 1505. All subsequent UE-specific signaling between HNB-2 1515 and the HNB-GW 1520 uses the UE 1505's signaling channel. HNB-2 1515 also includes its GTP-U tunnel endpoint IP address and locally-allocated TEID(s) to be used for the PS transport channel(s).

The GTP-U Relay function detects the RELOCATION REQUEST ACK message on the new UE signaling channel to obtain (a) the UE IMSI, and (b) the GTP-U tunnel endpoint IP address(es) and TEID(s) allocated by HNB2. It is prepared to switch the GTP-U path on receipt of the RELOCATION DETECT message on the new signaling channel (step 11).

The HNB-GW 1520 relays (in step 8) the RELOCATION COMMAND to HNB-1 1510 including the details on the target resource allocation. HNB-1 1510 considers the cell update relocation preparation to be complete when this message is received and takes no further action. In some embodiments, the HNB-GW 1520 does not include the “RABs Subject To Data Forwarding List” IE. Therefore, the HNB-1 1510 does not perform data forwarding for any RABs during PS handover.

Next, HNB-2 1515 sends (in step 9) the Cell Update Confirm message to the UE 1505 over the Uu interface, including the Physical channel information elements. The UE 1505 acts on all parameters received in the Cell Update Confirm message and sends (in step 10) the Physical Channel Reconfiguration Complete message to HNB-2 1515 on the Uu interface. HNB-2 1515 confirms (in step 11) that the UE has successfully reconfigured the physical channel resources, using the RELOCATION DETECT message, sent via the UE 1505's signaling channel. At this point, the GTP-U Relay function in the HNB-GW 1520 switches the PS transport channel path, relaying downlink packets associated with the GTP-U tunnel(s) to the HNB-2 1515 IP address and TEID(s) detected in the RELOCATION REQUEST ACK message monitored in step 7 and relaying uplink packets from HNB-2 1515 to the core network 1525.

HNB-2 1515 confirms the completion of the Cell Update to the HNB-GW by sending (in step 12) the RELOCATION COMPLETE message. Bi-directional PS traffic is now flowing (in step 13) between the UE 1505 and CN 1525, via HNB-2 1515 and the HNB-GW 1520 GTP-U Relay function. The HNB-GW 1520 deregisters the UE 1505 on HNB-1 1510 by sending (in step 14) the DEREGISTER message with reject cause value ‘Inter-HNB cell update complete’. HNB-1 1510 releases the resources assigned to the UE 1505 and deletes all stored context information associated with the UE 1505. The HNB-GW 1520 sends (in step 15) a REGISTER UPDATE DOWNLINK message to HNB-2 1515 on the UE 1505's signaling channel, providing any UE-specific service parameters. This step occurs any time after the HNB-GW 1520 receives the RELOCATION DETECT message.

8. Handling Cell Update Procedure in Inter-HNB Mobility Scenarios

The 3GPP specification in release 8 for support of Femtocell or HBN (3GPP TS 25.467: “UTRAN architecture for 3G Home NodeB; Stage 2”, 3GPP TS 25.468: “UTRAN Iuh Interface RANAP User Adaption (RUA) signalling”, and 3GPP TS 25.469: “UTRAN Iuh interface Home Node B Application Part (HNBAP) signalling”) does not account for scenarios covering connected mode mobility (i.e., handover or relocation) from one HNB to another HBN. Specifically, the inter HNB mobility using the cell update procedures as described in “Radio Resource Control (RRC); Protocol specification,” 3GPP TS 25.331, hereinafter “TS 25.331,” is not handled. The cell update procedure is triggered by the UE when it reselects to a new cell (HNB) in the RRC Connected State as described in TS 25.331. A novel solution for handling the cell update procedure associated with inter-HNB mobility is described in the following section.

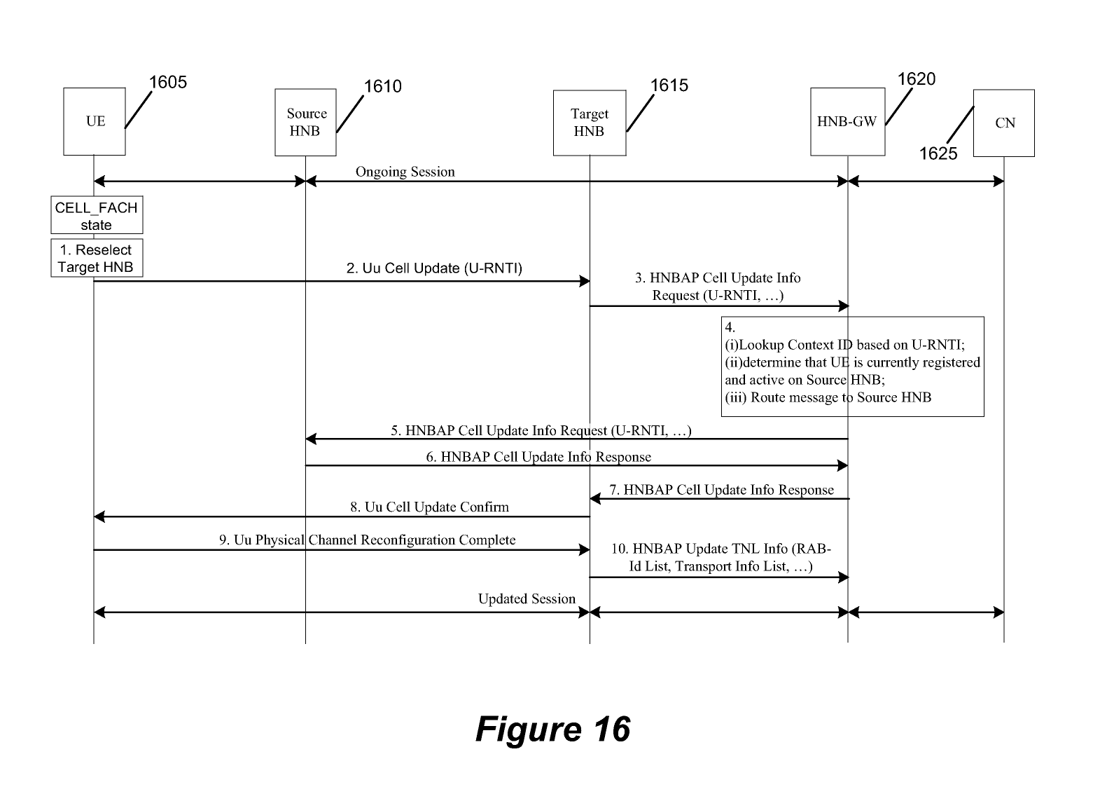

FIG. 16 illustrates cell update handling of some embodiments. The following mechanisms can be used to handle the cell update procedures due to inter-HNB mobility. The description of the procedure assumes that the UE has one or more active PS session on source HNB but has moved to the CELL_FACH state

As shown, UE 1605 re-selects (in step 1) to Target HNB 1615 while in the CELL_FACH state. UE 1605 sends (in step 2) a Cell Update message to Target HNB 1615 including the U-RNTI assigned to the UE 1605 by Source HNB 1610. Target HNB 1615 determines that the RNC-ID portion of the U-RNTI corresponds to one of the RNC-IDs that is assigned to Target HNB 1615's HNB-GW 1620. Target HNB 1615 learns the RNC-ID(s) that is (are) assigned to the HNB-GW 1620 during the HNB registration process.

Next, Target HNB 1615 sends (in step 3) a “HNBAP Cell Update Info Request” message to the HNB-GW 1620 including the received U-RNTI value. This information request allows the Target HNB 1615 to request the necessary information from the original Source HNB 1610 via HNB-GW 1620 for handling the cell update request at the target HNB 1615. The HNB-GW 1620 looks up (in steps 4(i)-4(iii)) the UE 1605's Context based on the U-RNTI value and determines that the UE 1605 is currently registered on Source HNB 1610 and has one or more active PS sessions. If the HNB-GW 1620 does not store the assigned U-RNTI value (e.g., during the setup of UE-associated signaling connection over the Iuh interface), then it is not possible for the HNB-GW 1620 to determine the UE 1605's context based on U-RNTI and it becomes necessary for Target HNB 1615 to request the UE 1605's IMSI from the UE 1605 (e.g., using an Identity Request message) between step 2 and step 3. This exposes the UE 1605's IMSI over the air interface which is a breach of identity confidentiality and it is desirable to avoid frequent identity request over the Uu interface.

The HNB-GW 1620 relays (in step 5) to the Source HNB 1610 the cell update info request message for that UE 1605. The Source HNB 1610 responds back (in step 6) in the HNBAP Cell Update Info Response carrying the necessary information to effectively move the allocated resources and stored UE context from Source HNB 1610 to Target HNB 1615. The HNB-GW 1620 relays (in step 7) to the Target HNB 1615 the cell update info response for that UE 1605.

Next, upon receiving the necessary information from the Source HNB 1610, the Target HNB 1615 sends (in step 8) the Cell Update Confirm message to the UE 1605 over the Uu interface, including the Physical channel information elements. The UE 1605 acts on all parameters received in the Cell Update Confirm message and sends (in step 9) the Physical Channel Reconfiguration Complete message (or equivalent Uu interface message) to Target HNB 1615 on the Uu interface. The Target HNB 1615 confirms (in step 10) that the UE 1605 has successfully reconfigured the physical channel resources and also indicates the updated transport layer information for the RABs which have been moved from the Source HNB 1610 to Target HNB 1615. This update of transport layer information is required since the RABs which were anchored at the Source HNB 1610 need to be re-anchored to the Target HNB 1615. At this point an updated session for the UE 1605 is successfully setup via the Target HNB 1615 and HNB-GW 1620 to the CN 1625.

The figures above may show various separate logical functions. In some embodiments, one or more logical functions can be implemented in a single hardware device. In some embodiments, one or more logical functions can be implemented in separate hardware devices. For example, FIG. 12, above, shows HNB-GW 1220 and HNB-GW MGW 1225 as two separate logical functions. In some embodiments, HNB-GW 1220 and HNB-GW MGW 1225 are implemented in a single hardware device. In some embodiments, HNB-GW 1220 is implemented in one hardware device and HNB-GW MGW 1225 is implemented in a separate hardware device.

### IV. COMPUTER SYSTEM

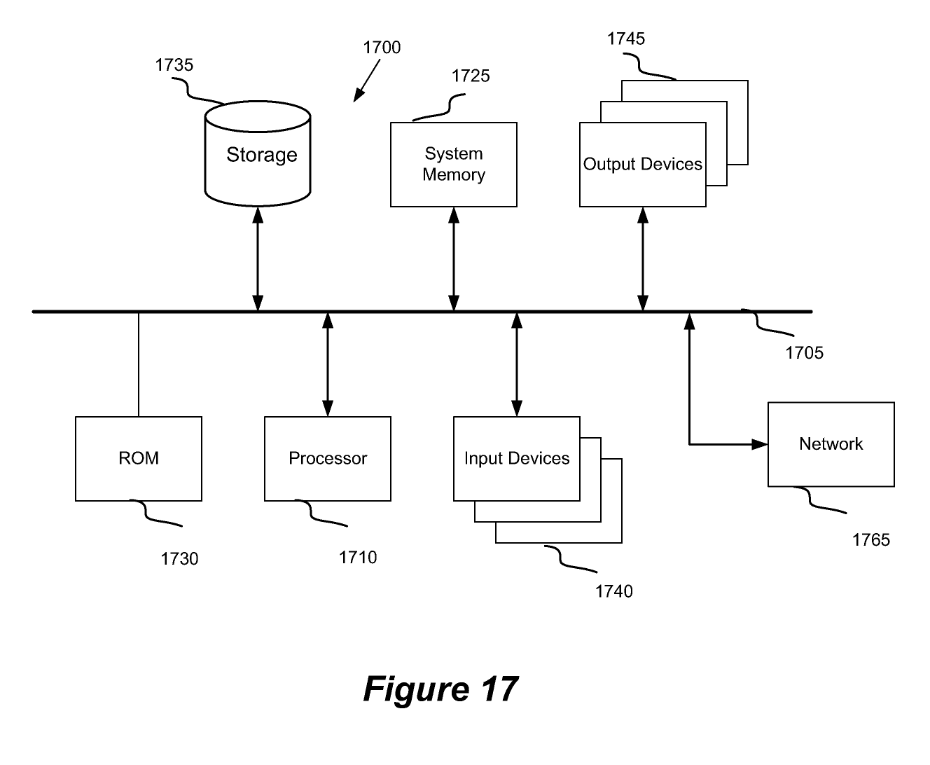

Computer programs for implementing some embodiments are executed on computer systems. FIG. 17 illustrates a computer system with which some embodiments of the invention are implemented. Such a computer system includes various types of computer readable media and interfaces for various other types of computer readable media. Computer system 1700 includes a bus 1705, a processor 1710, a system memory 1725, a read-only memory 1730, a permanent storage device 1735, input devices 1740, and output devices 1745.

The bus 1705 collectively represents all system, peripheral, and chipset buses that communicatively connect the numerous internal devices of the computer system 1700. For instance, the bus 1705 communicatively connects the processor 1710 with the read-only memory 1730, the system memory 1725, and the permanent storage device 1735.

From these various memory units, the processor 1710 retrieves instructions to execute and data to process in order to execute the processes of the invention.

The read-only-memory (ROM) 1730 stores static data and instructions that are needed by the processor 1710 and other modules of the computer system. The permanent storage device 1735, on the other hand, is a read-and-write memory device. This device is a non-volatile memory unit that stores instructions and data even when the computer system 1700 is off. Some embodiments of the invention use a mass-storage device (such as a magnetic or optical disk and its corresponding disk drive) as the permanent storage device 1735.

Other embodiments use a removable storage device (such as a floppy disk, flash drive, or ZIP® disk, and its corresponding disk drive) as the permanent storage device. Like the permanent storage device 1735, the system memory 1725 is a read-and-write memory device. However, unlike storage device 1735, the system memory is a volatile read-and-write memory, such a random access memory. The system memory stores some of the instructions and data that the processor needs at runtime. In some embodiments, the invention's processes are stored in the system memory 1725, the permanent storage device 1735, and/or the read-only memory 1730.

The bus 1705 also connects to the input and output devices 1740 and 1745. The input devices enable the user to communicate information and select commands to the computer system. The input devices 1740 include alphanumeric keyboards and pointing devices (also called “cursor control devices”). The output devices 1745 display images generated by the computer system. For instance, these devices display a GUI. The output devices include printers and display devices, such as cathode ray tubes (CRT) or liquid crystal displays (LCD).

Finally, as shown in FIG. 17, bus 1705 also couples computer 1700 to a network 1765 through a network adapter (not shown). In this manner, the computer can be a part of a network of computers (such as a local area network (“LAN”), a wide area network (“WAN”), or an Intranet, or a network of networks, such as the internet. For example, the computer 1700 may be coupled to a web server (network 1765) so that a web browser executing on the computer 1700 can interact with the web server as a user interacts with a GUI that operates in the web browser.

Any or all components of computer system 1700 may be used in conjunction with the invention. One of ordinary skill in the art would appreciate that any other system configuration may also be used in conjunction with the present invention.

As mentioned above, some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, ultra density optical discs, any other optical or magnetic media, and floppy disks. The computer-readable media may store a computer program. The computer program (i.e., the instructions of the computer program) is executable by a device such as an electronics device, a microprocessor, a processor, a multi-processor (e.g., a chip with several processors on it), a user equipment, a mobile station, an HNB, an HNB-GW, etc. The computer program excludes any wireless signals, wired download signals, and/or any other ephemeral signals.

Examples of hardware devices configured to store and execute sets of instructions include, but are not limited to, ASICs, FPGAs, programmable logic devices (“PLDs”), ROM, and RAM devices. Examples of computer programs or computer code include machine code, such as produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of this specification, the terms display or displaying mean displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and/or any other ephemeral signals.

It should be recognized by one of ordinary skill in the art that any or all of the components of computer system 1700 may be used in conjunction with the invention. Moreover, one of ordinary skill in the art will appreciate that any other system configuration may also be used in conjunction with the invention or components of the invention.

While the invention has been described with reference to numerous specific details, one of ordinary skill in the art will recognize that the invention can be embodied in other specific forms without departing from the spirit of the invention. For example, some or all components of the computer system described with regards to FIG. 17 comprise some embodiments of the UE, HNB, HNB-GW, and SGSN described above. Moreover, one of ordinary skill in the art will appreciate that any other system configuration may also be used in conjunction with the invention or components of the invention.

### V. DEFINITIONS AND ABBREVIATIONS

AAA Authorization, Authentication, and Accounting
AP Access Point
ATM Asynchronous Transfer Mode
BSS Base Station Subsystem
CGI Cell Global Identification
CM Connection Management
CN Core Network
CS Circuit Switched
DNS Domain Name System
EAP Extensible Authentication protocol
EDGE Enhanced Data Rates for GSM Evolution
ESP Emergency Services Protocol or Encapsulating Security Payload (IPSEC)
FACH Forward Access Channel
FQDN Fully Qualified Domain Name
GAN Unlicensed Mobile Access
GANC GAN Network Controller
GERAN GSM/EDGE Radio Access Network
GGSN Gateway GPRS Support Node
GPS Global Positioning System
GSM Global System for Mobile communications
GSN GPRS Support Node
GTP GPRS Tunneling Protocol
HNB Home Node B
HNBAP HNB Application Protocol
HNB-GW HNB Gateway
HPLMN Home PLMN
IE Information Element
IKEv2 Internet Key Exchange Version 2
IMSI International Mobile Subscriber Identity
INC IP Network Controller
IP Internet Protocol
IPSEC IP Security
ISDN Integrated Services Digital Network
ISP Internet Service Provider
M Mandatory
MAC Medium Access Control or Message Authentication Code (same as MIC)
MAP Mobile Application Part
MG or MGW Media Gateway
MM Mobility Management
MS Mobile Station
MSC Mobile Switching Center
NAS Non Access Stratum
PCS Personal Communications Services
PDP Packet Data Protocol, e.g., IP or X.25[34]
PDU Protocol Data Unit
PLMN Public Land Mobile Network
PS Packet Switched
PSAP Public Safety Answering Point
P-TMSI Packet TMSI
QoS Quality of Service
RA Routing Area
RAB Radio Access Bearer
RAC Routing Area Code
RADIUS Remote Authentication Dial-In User Service
RAI Routing Area Identity
RANAP Radio Access Network Application Part
RFC Request for Comment (IETF Standard)
RNC Radio Network Controller
RNC-ID Radio Network Controller Identifier
RNTI Radio Network Temporary Identifier or Radio Network Temporary Identity
RRC Radio Resource Control
RTP Real Time Protocol
RUA RANAP user Adaptation
SAC Service Access Control
SCCP Signaling Connection Control Part
SCTP Stream Control Transmission Protocol
SeGW GANC Security Gateway
SGSN Serving GPRS Support Node
SIM Subscriber Identity Module
SRNS Source Radio Network Subsystem
S-RNTI Serving RNC RNTI
SSID Service Set Identifier (also known as “Network Name”)
TA Timing Advance
TCP Transmission Control Protocol
TMSI Temporary Mobile Subscriber Identity
UE User Equipment
UMA Unlicensed Mobile Access
UMTS Universal Mobile Telecommunication System
UNC UMA Network Controller
U-RNTI UTRAN Radio Network Temporary Identifier or UTRAN Radio Network Temporary Identity
USIM Universal Subscriber Identity Module
VLR Visited Location Register

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. Moreover, while the invention has been described with reference to numerous specific details, one of ordinary skill in the art will recognize that the invention can be embodied in other specific forms without departing from the spirit of the invention.

In some examples and diagrams, two components may be described or shown as connected to each other. The connection may be a direct wire connection or the two components may be communicatively coupled to each other through other components or through wireless or broadband links. Thus, one of ordinary skill in the art would understand that the invention is not to be limited by the foregoing illustrative details, but rather is to be defined by the appended claims.

What is claimed is:

1. A method of managing user equipment (UE) identifiers in a communication system comprising (i) a first wireless communications system comprising a licensed wireless radio access network and a core network and (ii) a second wireless communications system comprising a plurality of short range access points for establishing service regions of the second wireless communications system using licensed wireless frequencies and a network controller for communicatively coupling a UE operating in the service regions to the core network, the method comprising:
receiving, at an access point, a radio resource control (RRC) connection request message from the UE;
allocating, by the access point, a first identifier to the UE;
sending a RRC connection setup message comprising the first identifier from the access point to the UE;
sending a request message from the access point to the network controller, the request message comprising a connection management services request message and said first identifier, wherein the network controller determines the first identifier is in use; and
sending a mobility info message from the access point to the UE, wherein the mobility info message comprises a second identifier, said second identifier different than the first identifier.

2. The method of claim 1, wherein a generation of the second identifier is triggered by the network controller determining that the first identifier is in use.

3. The method of claim 2, wherein said generation of the second identifier comprises:
allocating, by the network controller, the second identifier that is not in use; and
sending the mobility info message comprising the second identifier to the access point.

4. The method of claim 3, wherein the mobility info message is a universal mobile telecommunication system (UMTS) terrestrial radio access network (UTRAN) mobility info message.

5. The method of claim 2, wherein the mobility info message is a Home Node B Application Part (HNBAP) UMTS terrestrial radio access network (UTRAN) mobility info message.

6. The method of claim 2, wherein said generation of the second identifier comprises:
receiving, by the access point, a disconnect message from the network controller, wherein the disconnect message indicates that the first identifier is in use; and
allocating, by the access point, the second identifier to the UE.

7. The method of claim 6, wherein the disconnect message is a RUA disconnect message.

8. The method of claim 1, wherein the request message is a start new session message.

9. The method of claim 1, wherein the request message is a radio access network application part (RANAP) User Adaptation (RUA) connect message.

10. The method of claim 1 further comprising sending a mobility info confirm message from the access point to the network controller causing the network controller to store the second identifier, wherein the access point receives the mobility info confirm message from the UE.

11. The method of claim 10, wherein the mobility info confirm message is a HNBAP UTRAN mobility info confirm message.

12. The method of claim 10, wherein the mobility info confirm message is a RUA connect message.

13. The method of claim 1, wherein the first identifier and the second identifier are UTRAN radio network temporary identifiers (U-RNTIs).

14. A computer readable medium storing a computer program for managing user equipment (UE) identifiers in a communication system comprising (i) a first wireless communications system comprising a licensed wireless radio access network and a core network and (ii) a second wireless communications system comprising a plurality of short range access points for establishing service regions of the second wireless communications system using licensed wireless frequencies and a network controller for communicatively coupling a UE operating in the service regions to the core network, the computer program executable by a processor, the computer program comprising sets of instructions for:
receiving, at an access point, a radio resource control (RRC) connection request message from the UE;
allocating, by the access point, a first identifier to the UE;
sending a RRC connection setup message comprising the first identifier from the access point to the UE;
sending a request message from the access point to the network controller, the request message comprising a connection management services request message and said first identifier, wherein the network controller determines the first identifier is in use; and
sending a mobility info message from the access point to the UE, wherein the mobility info message comprises a second identifier, said second identifier different than the first identifier.

15. The computer readable medium of claim 14, wherein a generation of the second identifier is triggered by the network controller determining that the first identifier is in use.

16. The computer readable medium of claim 15, wherein the set of instructions for the generation of the second identifier comprises sets of instructions for:
receiving, by the access point, a disconnect message from the network controller, wherein the disconnect message indicates that the first identifier is in use; and
allocating, by the access point, the second identifier to the UE.

17. The computer readable medium of claim 16, wherein the disconnect message is a RUA disconnect message.

18. The computer readable medium of claim 14, wherein the request message is a start new session message.

19. The computer readable medium of claim 14, wherein the request message is a radio access network application part (RANAP) User Adaptation (RUA) connect message.

20. The computer readable medium of claim 14, wherein the first identifier and the second identifier are UTRAN radio network temporary identifiers (U-RNTIs).
